(19) United States
(12) Patent Application Publication
(10) Pub. No.: US 2009/0111709 A1
(43) Pub. Date: Apr. 30, 2009

(54) Affinity Measurements Using Frameless Multiplexed Microarrays

(76) Inventors: Thomas J. Burke, Madison, WI (US); Tobias C. Zutz, Madison, WI (US); Randall J. Wagner, Waunakee, WI (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(21) Appl. No.: 12/260,537

(22) Filed: Oct. 29, 2008

Related U.S. Application Data
(63) Continuation-in-part of application No. 12/233,140, filed on Sep. 18, 2008.
(60) Provisional application No. 60/983,507, filed on Oct. 29, 2007.
(60) Provisional application No. 60/994,179, filed on Sep. 18, 2007.

(51) Int. Cl. C40B 30/04

(52) U.S. Cl. 506/9

(57) ABSTRACT

The present invention relates to novel methods of the quantitative detection of molecules in an array. In particular, the present invention relates to methods for molecular detection assays performed on solid surfaces. The present invention provides improved methods for the high throughput analysis of molecular interactions and quantitative detection. In another aspect, the invention relates to a method of measuring protein interactions on a solid surface that is useful for the determination of equilibrium binding and rate constants. In yet another aspect, the invention relates to predicting a molecules utility in a detection assay.

### CROSS-REFERENCE TO RELATED APPLICATIONS

This application claims the benefit of U.S. Provisional Application No. 60/983,507, filed Oct. 29, 2007, and is a continuation-in-part of U.S. patent application Ser. No. 12/233,140, filed Sep. 18, 2008, which claims the benefit of U.S. Provisional Application No. 60/994,179 filed Sep. 18, 2007. The contents of these applications are fully incorporated herein by reference.

### FIELD OF THE INVENTION

The present invention relates to novel assay methods for the quantitative measurement of molecules. In one aspect, the present invention relates to a method of detecting molecular interactions. In another aspect, the invention relates to inexpensive, miniaturized, and multiplexed high throughput materials and methods that can be used to identify reagents useful in protein detection assays. In yet another aspect, the present invention relates to methods and reagents that utilize a frameless microarray and can generate hundreds, thousands and tens of thousands of data points per experiment. In another aspect, the invention relates to a method of measuring protein interactions on a solid surface that is useful for the determination of equilibrium binding and rate constants. In yet another aspect, the invention relates to predicting the utility of a molecule in a detection assay.

### BACKGROUND OF THE INVENTION

### Proteins:

Proteins are the effectors of cellular structure and function. They provide a complexity so extraordinary as to seem impossible. There are only about 30,000 human genes but several layers of genetic and biochemical complexity produces more than a million protein variants. These variants are produced by many interacting systems including allelic variation, alternate RNA splicing, dozens of post-translational protein modifications, and proteolytic cleavages and/or ligations. This increasingly complex human proteome challenges researchers to find better biophysical methods and reagents to quantitatively detect large numbers of protein markers with specificity and accuracy.

Protein detection requires high quality reagents for all aspects of the assays. These include reagents for preparing sample extracts, labeling proteins, selectively binding proteins, and amplifying assay detection signals. One of the most formidable tasks in protein detection is to find the molecular tweezers that can specifically and with high affinity, bind to a protein in a very complex background.

Proteins are linear polymers of amino acids; the primary sequence is defined by the actual sequence of the 20 amino acids. Post-translational modifications such as phosphorylation, methylation, acetylation, amidation, and glycosylation create very large numbers of protein variants. Other protein modification mechanisms such as ubiquitinylation, sumoylation, or ISGylation, create a variety of protein structures. Proteins may exhibit localized folding (secondary structure) in parts of the amino acid polymer such as alpha helixes or beta sheets. The tertiary structure of a protein is the folding pattern throughout the molecule; it defines the three-dimensional shape. Protein function is related to its tertiary structure and this relationship is a core tenet of structural biology. An isolated protein is thought to be in its native conformation when it retains the same tertiary structure inside and outside the cell. When proteins bind together, the quaternary protein structure is formed. The specific detection of proteins relies not only on the primary sequence of amino acid but also on the specific three dimensional structure.

### Detection Assays

Protein assays, where single or multiple analytes can be detected per sample, have been developed in several homogeneous and non-homogeneous formats. All assays require some physical manipulation of the detection reagents and/or analytes. These include: radioactive, biochemical or fluorescent labeling, and solid support immobilization. The surfaces include: (1) microbeads; (2) arrays on planar surfaces; (3) arrays on three-dimensional surfaces such as nitrocellulose and hydrogels; and (4) arrays in microplate wells. Label-free detection systems, such as surface plasmon resonance or arrayed imaging reflectometry, do not require analyte labeling but do require immobilization on a gold surface. On the other hand, fluorescence polarization (anisotropy) assays require fluorescent tracer labeling but no immobilization to a solid surface. In all cases, the assay detection reagents must manifest proper affinity and specificity that are appropriate to the both the sample material as well as the analyte quantitation.

Each assay format has advantages and disadvantages for specific applications. Some of the common disadvantages include the high cost of assay equipment and reagents, the limitations on the number of analytes that can be multiplexed, the inability to perform multiplexing in a high throughput mode, and the time and expense involved in the customization of each assay. Some assay methods are suitable for large proteome projects dealing with small sample numbers studying thousands of different proteins while other methods are more suited for dealing with only dozens of proteins from thousands of samples.

The assay reagents used to bind the analyte may be antibodies, antibody mimetics, RNA, DNA, or peptide aptamers, small molecules, or proteins based on novel protein scaffolds. The choice of detection reagents and methods depends on the statistical quality required (accuracy, precision, limit of quantitation, etc.), the background in the test sample, and the availability of affordable instrumentation to build the assay and perform the analytical measurements. A significant consideration is the length of time and expense involved in selecting the detection reagents for a new assay.

One of the most common protein detections assays is the immunoassay, which can be configured in a multitude of ways. The three most common formats are: (1) the single antibody array; (2) the dual (matched) antibody array; and (3) the antigen array. The single antibody and the antigen arrays can be multiplexed with hundreds of analytes but vary in specificity, sensitivity, and quantitativeness. Often these assays are designed as semi-quantitative (e.g. ratiometric). Dual antibody assays can give high quality, quantitative data but are limited in multiplexing by the number of matched antibody pairs that can be identified. Because of the time involved in screening for matched antibody pairs with current methods, dual antibody assays can be expensive to develop.

With regard to the sandwich ELISA immunoassay, a capture antibody, which captures the analyte, is bound to a solid surface and the surface is blocked with a non-specific reagent. A sample is added that contains the analyte, the captured analyte is washed with buffer and a second antibody (detection antibody) is added that recognizes a portion of the analyte, which is distinct from the binding site of the first antibody. The second antibody is then detected directly or indirectly by a variety of methods. In another form of the immunoassay, a capture antibody is attached to a surface. Next, the surface is blocked with a non-specific reagent, and a sample is added that contains a labeled analyte. Finally, the captured analyte is washed with a buffer and the labeled analyte is detected directly or indirectly. In yet another form of the immunoassay, an analyte is attached to surface and blocked with a non-specific reagent. A sample containing an antibody, such as serum, is then added. Next, the captured antibody is washed with buffer, and the antibody is detected directly or indirectly. The dual antibodies for these assays must demonstrate appropriate (often very high) affinity, high specificity and most importantly, must not show interference between the capture and detection antibodies.

In some assays, the detectable moieties can be positioned on many components of the assay, including the analyte. For example, fluorescence assays can be designed so that one or more assay components are fluorescently labeled and various fluorescent properties are measured. These include assays involving fluorescence intensity, fluorescence lifetime, fluorescence resonance energy transfer, fluorescence polarization (anisotropy), and time-resolved fluorescence. The dynamic range of an immunoassay can be >1000 and the detection limit varies, but a common lower limit for protein detection is approximately 1-10 pg/ml of analyte. Immunoassays have been modified with different sample extraction protocols and many different natural and synthetic surfaces have been utilized. Other modes of detection are reviewed in Reviews in Fluorescence 2004 (Chris D. Geddes and Joseph R. Lakowicz).

Immunoassays often are used to detect proteins from a variety of sources including viruses, prions, bacteria, fungi, and plant or animal fluids, cells, or tissues. The source of the protein is not limited for immunoassays but in many cases, the protein is extracted and partially purified before it can be used. Many different extraction procedures have been developed, which include physical methods such as freeze-thaw cycling, sonication, high temperature or high pressure (French Press) treatment, or glass bead vortexing. Other methods employ chemical or biochemical methods, such as detergent disruption, enzymatic lysis, or creating a strongly reducing environment. Commonly, extraction methods incorporate a combination of both physical and chemical treatments. After the initial treatment, a separation step is commonly employed such as centrifugation, magnetic particle separations, phase separations, or precipitation reactions to further clarify the sample for detection.

There are several limitations to all multiplexed arrays, whether they are on beads, in microplate wells or on planar or three-dimensional slides. For arrays in microplate wells, it is difficult to find a robust arraying method that can deposit a high number of protein spots in a timely manner into the bottom of the well. The array detection in microplate wells is often by chemiluminescence; therefore the spots cannot be spaced as close together as in fluorescence detection. In 96 well microplates, the large sample volumes can also be a limiting factor. The 384 well microplate requires less sample but fewer spots can be arrayed in the well bottom. For all multiplexed immunoassays, finding antibodies that show acceptable sensitivity and specificity without cross-reacting with other antibodies is a significant and expensive challenge.

Bead-based detection systems have been developed to allow analysis of several analytes simultaneously. The multiplexed bead array format commercialized by LUMINEX (Luminex Corp., Austin, Tex.), called xMAP system uses antibody-coated colored latex particles to capture analytes, which then are detected by a second labeled antibody. Each uniquely colored bead has a different capture antibody allowing mixtures of several beads. The particles are directed through a flow cytometer that identifies the particle based on the bead color (fluorescence) and measures the fluorescence of the detection antibody associated with that bead. One drawback to this method is that the capture antibodies sometimes are inactivated when they are covalently immobilized to the latex beads. In addition, the assay still requires a significant, sometime excessive, sample volume. This system also is limited in the number of assays that can be multiplexed typically is only a few dozen.

### Detection Methods

Three common methods for detecting proteins on surfaces are enzyme-linked immunosorbent assay (ELISA), fluorescence immunoassay (FIA), and surface plasmon resonance (SPR). Colorimetric detection in an ELISA uses an enzyme, such as alkaline phosphatase or horseradish peroxidase that is conjugated to the detection antibody and uses colorimetric enzyme substrates. These conjugated enzymes can also use chemiluminescent substrates. Tyramide signal amplification can also be used amplify the detection beyond standard enzymatic methods. SPR does not require protein labeling but it does require protein immobilization; it is a suitable technique for direct capture antibody or antigen assays. However, the technique has not been sufficiently developed for multiplexed microarrays.

### Surfaces

Nitrocellulose (cellulose nitrate) has been used for protein and nucleic acid binding experiments, demonstrating its versatility, robustness, and affordability. Proteins, including antibodies, placed directly on hydrophobic surfaces such as glass or plastic will partially denature, reducing protein activity. However, the porous, polymeric features of nitrocellulose allow binding through hydrophobic interactions, hydrogen bonding, and Van der Waals interactions that minimally disrupt the protein. Proteins can be spotted (dot blots) or transferred from a polyacrylamide gel electrophoresis (PAGE), as typically performed in a Western blot.

In addition to its use in life science research and diagnostic assays, nitrocellulose has been used as a component in explosives, photography papers, paints and lacquers, and ink for inkjet printers. Due to this widespread use, it continues to be developed and better characterized as a raw material, especially for analytical purposes. Many different grades of nitrocellulose can be purchased based on purity, nitrogen content, viscosity (molecular weight), solvents, wetting agents, phlegmatizers, and plasticizers. Two common suppliers are Wolff Cellulosics (Walsrode Industrial Park) and Filo Chemicals (New York, N.Y.); many other suppliers exist worldwide.

For diagnostic and life science research applications, nitrocellulose is commonly used in two forms: a white stand alone membrane or a coating on a surface, usually glass. The fluorescence background of a white, porous nitrocellulose surface is always significantly higher than a thin optically clear nitrocellulose surface. The coated surface ranges from thick (>10 μm) white, porous coating such as slides from Schleicher and Schull (Whatman, Middlesex, UK) and Grace BioLabs (Bend, Oreg.) to an optically clear, ultra-thin coating (<500 nm) slides from GenTel Biosciences (Madison, Wis.). The physical properties of applied nitrocellulose such as thickness, porosity, hydrophobicity, strength, adhesiveness, homogeneity, and protein binding capacity are determined by a large number of factors. These include the ratio of solvents, co-solvents and non-solvents, the drying conditions including temperature, humidity, and solvent partial pressures, and the presence of other molecules such as plasticizers, stabilizers, and other cellulose esters.

Numerous methods are available to deposit nitrocellulose on surfaces, such as spraying (atomization), dip coating, or pipetting solutions; the method of deposition contributes to the thickness and the physical properties of the final product. Most coatings cover the entire surface but in some cases, dots or islands of nitrocellulose are deposited on sections of the glass surface. Grace BioLabs (Bend, Oreg.) has produced the ONCYTE film-wells for cell based microarrays in which multiple nitrocellulose dots are affixed to a glass microscope slide. However, the area on the slide between the white dots is not described as hydrophobic and when tested, this area does not demonstrate hydrophobicity. The lack of hydrophobicity between the dots contributes to cross-contamination of samples, and reduces assay throughput. Recently, GenTel Biosciences (Madison, Wis.) introduced a thin-film (<0.5 micron) nitrocellulose coated glass slide (licensed from Clinical MicroArrays, now called Decision Biomarkers, Natick, Mass.). Other companies, Agnitio Science & Technology (Taiwan) and PriTest (Redmond, Wash.) have also produced nitrocellulose coated slides for protein detection.

The multiplexing glass slide is designed to be used with a removable silicone gasket (frame, well former) that creates multiwells to isolate specimens and reagents and to prevent cross contamination (FIG. 1). In the absence of a frame to create the wells, solutions that are applied to the nitrocellulose areas easily flow across the slide and fail to remain isolated. Grace slides and accessories (frames) are available through many other companies such as Interchim (Interchim.com (France), Stratech (Suffolk, England), and Invitrogen (Carlsbad, Calif.).

The challenge of the above-mentioned frame or well-former is that the bottom, usually silicone, must seal very tightly yet still be removed at the end of the assay without destroying the molecular binding surface. The 16 well frame does not perform well on all surfaces, such as a white, thick, porous nitrocellulose surface. The slides with thicker nitrocellulose surfaces must be segmented so that the frame only fits where the nitrocellulose has been removed. The 16 pad slides from Grace Laboratories, (Bend, Oreg.) are prepared by coating an entire glass slide with nitrocellulose then removing the nitrocellulose between the 16 pads. However, when samples are applied to the pads without a frame, the liquid samples easily run off the nitrocellulose pads and across the slide. More recently, frames for 64 and 96 nitrocellulose pads have been developed by Grace Biolabs (Bend, Oreg.) and Gentel Biosciences (Madison, Wis.).

Other methods used to separate samples on a microarray involve using hydrophobic ink to create small hydrophobic islands on a hydrophilic surface. The service of applying hydrophobic ink to slides is offered by Erie Scientific Company (Portsmouth, N.H.). There are several limitations to using hydrophobic ink. If the ink is applied first to the array to contain the liquid nitrocellulose formulation, the dried ink must be chemically compatible with many different nitrocellulose chemical formulations. On the other hand, if the surrounding hydrophobic ink is applied after the nitrocellulose dots are deposited, the ink solvent must not dissolve the nitrocellulose or leach into the nitrocellulose dot. Also, the hydrophobic ink could interfere with protein interactions.

A further limitation is that the dried hydrophobic ink creates a three-dimensional containment area around the deposited nitrocellulose, and therefore, even if the ink wall is a small distance above the surface, the wall may interfere with rapid dispensing methods, which require the dispensing head to operate extremely close to the nitrocellulose surface. Another limitation of the hydrophobic ink is the additional time and expense of creating an array. If the hydrophobic ink is placed on the array before the nitrocellulose, the inkjet dispensing must be very accurately placed in a circular, square, or other containment configuration and yet still allow rapid, even disposition of a liquid nitrocellulose composition within that contained space. If the hydrophobic ink is placed on the surface after the nitrocellulose dot deposition, the ink must surround the dot very accurately, even if the dot does not have exact, uniform dimensions. The hydrophobic ink deposition is especially problematic when the nitrocellulose dots are further miniaturized.

Therefore, the need still exists for a method of generating a solid surface substrate useful for the quantitative detection of molecules in an array that provides minimal cross-contamination and high-throughput analysis. The present invention eliminates the need for frames by chemically (hydrophobicly) isolating hydrophilic sections. The combination of these two types of surfaces, combined with the absorbent nature of the porous hydrophilic membrane, provides the means to keep applied samples isolated. The present invention utilizes a frameless microarray comprising isolated hydrophilic islands or “dots” separated by hydrophobic regions, wherein the array can be used to determine kinetic and equilibrium binding data on a large number of samples.

### SUMMARY OF THE INVENTION

The present invention relates to methods and apparatuses for quantitatively detecting molecules. In yet another aspect, the present invention relates to methods for measuring equilibrium data in a multiplexed array. In one embodiment, protein binding assays are performed on a solid surface for the quantitative, multiplexed detection of molecules without the need for frames or wells to separate samples. The present invention does not rely on hydrophobic ink, enhanced structures, depressed structures, or three dimensional chemical enhancement of the area surrounding the hydrophilic membrane.

The methods of the present invention can be used in formats of 96 (e.g., 8×12), 384 (e.g., 16×24), 1536 (e.g., 32×48) or 3,456 nitrocellulose dots by directly dispensing liquid nitrocellulose onto a surface. The methods of the present invention are much simpler than incorporating hydrophobic ink or using well-framers. This invention is preferable to using hydrophobic ink because it eliminates the aforementioned strict chemical compatibility and spatial requirements.

In another aspect, the invention relates to a method of measuring protein interactions on a solid surface that is useful for the determination of equilibrium binding and rate constants. In yet another aspect, the invention relates to a method of predicting the utility of a molecule in a detection assay. In another embodiment, the present invention can be used to simultaneously measure the binding kinetics, including but not limited to association and dissociation constants, between a group of proteins and a single binding partner.

In one embodiment, hydrophilic sections (“dots”) including but not limited to 96, 384, 1,536 or 3,456 hydrophilic sections, are generated on a surrounding hydrophobic surface, which allows the protein-containing samples to remain chemically isolated. Antigen arrays are arrayed on each of the hydrophilic membrane dots.

In another embodiment, the methods of the present invention can be used to simultaneously determine both the equilibrium binding data and the specificity of protein binding. Any number of proteins, including 2, 3, 4, 5, 6, 7, 8, 9, 10, 11-15, 16-20, 21-30, 31-40, 41-50, 50-100, 100-1000, 1000-3500, 3500-5000, and greater than 5,000 proteins, can be assayed in a 96, 384, 1536 or 3456 well grid. The simultaneous determination of binding parameters between an antibody and several proteins has great utility in designing multiplexed assays. For instance, the methods of the present invention can be used to identify matched pairs of antibodies or to select antibodies with high affinity and specificity for a single target for use in reverse phase protein extract arrays.

In another embodiment, a frameless, hydrophilic membrane multiplexed array can be used to determine the binding kinetics of a biochemical binding reaction. The time course of binding can be measured over any appropriate time period, including but not limited to 0.1-1, 1-5, 5-10, 10-15, 15-20, 20-25, 25-30, and greater than 30 hours, to determine the extent of direct binding. In another embodiment, the association and dissociation rate constants, and the equilibrium binding constant can be determined by incubating samples on an antigen array for a given period of time and then performing a quantitative ELISA on the supernate to determine the amount of unbound ligand.

In another embodiment, a frameless, hydrophilic membrane multiplexed array can be used to determine the inhibitory concentrations of analytes. An antigen array is developed to measure antibody binding to an antigen bound to the surface. The same diluted, soluble antigen can then be used to determine competitive binding in the assay. The IC₅₀ can then used to calculate the Kᵢ value.

In yet another embodiment, the present invention relates to a method comprising: (a) arraying antigens on a frameless multiplexed array; and (b) creating smaller arrays from the array created in (a); and (c) assaying for protein interactions on the smaller arrays. The array created in step (a) can be cut into smaller arrays using any means that does not disrupt the function of the array including but not limited to scissors, chemicals, enzymes, or lasers.

In still another embodiment, the present invention relates to a method for assaying molecular interactions comprising: (a) applying a sample to a microarray; and (b) measuring a molecular interaction between at least two molecules. In another embodiment, the microarray is a frameless array. In yet another embodiment, the frameless array comprises: (a) at least two segregated membranes coupled to a substrate, wherein said membranes comprise a composition comprising nitrocellulose, and further wherein said composition is formulated to maintain an applied fluid within the perimeter of the membrane and (b) an analyte coupled to said membranes. In yet another embodiment, the analyte is selected from the group consisting of: a probe, an antibody, RNA, DNA, a peptide, an extract, a fragment of a protein, an antibody, and a protein. In still yet another embodiment, the frameless array comprises 96, 384 or 1,536 segregated membranes.

In yet another embodiment, the present invention relates to a method for assaying a molecular interaction comprising: (a) applying a sample to a microarray, wherein at least one target molecule is coupled to the surface of said microarray; (b) quantifying the amount of an antibody in said sample; and (c) measuring the equilibrium binding between said antibody and said target molecule.

In another embodiment, the present invention relates to a method for assaying a molecular interaction comprising: (a) applying a sample to a microarray; (b) measuring binding between an antibody and a target molecule coupled directly to the microarray surface; and (c) measuring binding between the antibody and the same target molecule coupled to the surface by another antibody, which binds to a different part of the target molecule.

In still yet another embodiment, the present invention relates to a method of assaying a molecular interaction comprising: (a) applying a sample to a frameless microarray; and (b) measuring a time course of equilibrium between at least two molecules. In another embodiment, at least one molecule is an antibody in solution and the time course of binding is measured to more than one protein target simultaneously. In yet another embodiment, the specificity of the antibody can be determined using known protein targets and non-specific proteins.

In another embodiment, the present invention relates to a method for assaying a molecular interaction comprising: (a) applying a sample containing an analyte to a frameless microarray, wherein said microarray has at least one target molecule and at least one non-target molecule coupled to the surface; (b) determining binding specificity of the analyte to the target molecule and the non-target molecule; and (c) determining a dissociation constant for the analyte and the target molecule and a dissociation constant for the analyte and the non-target molecule. In yet another embodiment, the analyte is an antibody. In still another embodiment, the method further comprises determining the isotype of the antibody. In yet another embodiment, the method further comprises determining the concentration of the antibody.

### BRIEF DESCRIPTION OF THE DRAWINGS

FIG. 1 is a schematic of an exemplary removable 16-well frame (well former) that is commonly used for slide arrays and often cumbersome to use.

FIG. 2 is a schematic of an exemplary array design using nitrocellulose sections (dots) on a hydrophobic surface. In the schematic, the assay example is a multiplexed sandwich ELISA using fluorescence detection and is provided for demonstration purposes.

FIG. 3 is a schematic of an exemplary array design using nitrocellulose sections (dots) on a hydrophobic surface. In the schematic, the assay example is a multiplexed antigen array using colorimetric detection. The assay can be used for several applications such as calculating the dissociation constant of an equilibrium binding constants for several proteins simultaneously.

FIG. 4 contains three photographs showing various arrays with varying numbers of membranes or dots on each array. FIG. 4A is a photograph of 96 nitrocellulose membranes (dots) on a hydrophobic glass surface. FIG. 4B is a photograph of 96 nitrocellulose membranes (dots) on a plastic surface. FIG. 4C is a photograph depicting 384 nitrocellulose membranes (dots) on a plastic surface. Each nitrocellulose membrane can be arrayed with molecules.

FIG. 5 is a schematic demonstrating a dissociation constant determination for an antibody. that one diluted antibody was used per column of proteins spots on nitrocellulose dots. Four columns are depicted; each experiment added diluted antibody to 12 nitrocellulose dots.

FIG. 6 is a graph reporting the equilibrium dissociation constant, Kd, for the IFN-gamma antibody (Ab1) to IFN-gamma as measured in a frameless, multiplexed, miniaturized antigen array.

FIG. 7 is a graph reporting the equilibrium dissociation constant, Kd, for the IFN-gamma antibody (Ab2) to IFN-gamma as measured in a frameless, multiplexed, miniaturized antigen array.

FIG. 8 is a graph reporting the equilibrium dissociation constant, Kd, for the IFN-gamma antibody (Ab3) to IFN-gamma, as measured in a frameless, multiplexed, miniaturized antigen array.

FIG. 9 is a graph reporting the equilibrium dissociation constant, Kd, for the anti-ovalbumin antibody to ovalbumin, as measured in a frameless, multiplexed, miniaturized antigen array.

FIG. 10 is a graph reporting the equilibrium dissociation constant, Kd, for the anti-ovalbumin antibody, bound to interferon-gamma with low affinity

FIG. 11 is a graph reporting the anti-ovalbumin binding to ovalbumin over a time course of about 18 hours, as measured in a frameless, multiplexed, miniaturized antigen array.

FIG. 12 is a graph reporting the inhibitory concentration (IC₅₀) of a soluble protein that competes for binding between an antibody and a protein bound to the surface of the array.

FIG. 13 is a photograph of an array depicting the matched pairs of antibodies that can be used in a calorimetric, sandwich ELISA.

FIG. 14 is a scanned image demonstrating both an antigen array and a sandwich ELISA on the same nitrocellulose area (dot) to identify matched pairs of antibodies.

FIGS. 15A-H are graphs reporting measurement to determine antibody concentration, to determine specific binding to a target, to determine specificity, and to determine the isotype. FIG. 15A depicts measurements for antibody 3G10C5. FIG. 15B depicts measurements for antibody 4E7H5. FIG. 15C depicts measurements for antibody 3F6B5. FIG. 15D depicts measurements for antibody 2E11F5. FIG. 15E depicts measurements for antibody 3G6E6. FIG. 15F depicts measurements for antibody 4H3B10 (anti-Brachyury). FIG. 15G depicts measurements for anti-Nanog antibody from eBiosciences. FIG. 15H depicts a mouse IgG standard curve.

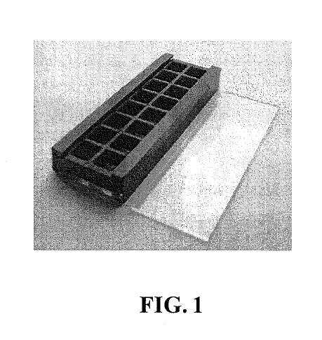

The objects and advantages of the invention will appear more fully from the following detailed description of the preferred embodiment of the invention made in conjunction with the accompanying drawings.

### DETAILED DESCRIPTION OF THE INVENTION

### Definitions

To facilitate an understanding of the present invention, a number of terms and phrases are defined below:

“Antibody mimetic” means a molecule that replicates essential features of an immunoglobulin, monoclonal or polyclonal antibody.

“Assay” and like terms means a procedure for detecting the presence, estimating the concentration, and determining the biological activity of a macromolecule, molecule, ion, or cell. Assays are based on measurable parameters that enable the evaluation of differences between samples and controls.

“Multiplex assay” means a procedure for the parallel analysis of samples.

“Serum” means the cell-free portion of the blood from which the fibrinogen has been separated in the process of clotting. The cell free portion of the blood (plasma) has a pH within the narrow range of 7.35 to 7.45 in healthy individuals.

“Sample” means a specimen or culture obtained from any source, as well as biological and environmental samples. Biological samples may be obtained from animals (including humans) and encompass fluids, solids, tissues, and gases. Biological samples include urine and blood products, such as plasma, serum and the like. Such examples are not however to be construed as limiting the sample types applicable to the present invention.

“Immunoglobulin” or “Antibody” means a protein that binds a specific antigen. Immunoglobulins include, but are not limited to, polyclonal, monoclonal, chimeric, and humanized antibodies, Fab fragments, F(ab′)₂ fragments, including immunoglobulins of the following classes: IgG, IgA, IgM, IgD, IgE, and secreted immunoglobulins (sIg). Immunoglobulins generally comprise two identical heavy chains and two light chains. However, the terms “antibody” and “immunoglobulin” also encompass single chain antibodies and two chain antibodies.

“Analyte” means a substance being measured in an analytical procedure and includes using the substance to determine the presence, absence or quantity of another substance.

“Antigen” means a substance capable, under appropriate conditions, of inducing a specific immune response and of reacting with the products of that response, which in preferred embodiments is a specific antibody. Antigens may be soluble substances, such as toxins and foreign proteins, or particulate, such as bacteria and tissue cells, however, only the portion of the antigen molecule known as the antigenic determinant or epitope combines with antibody.

“Specific binding” or “specifically binding” when used in reference to the interaction of an antibody and a protein or peptide means that the interaction is dependent upon the presence of a particular structure (i.e., the antigenic determinant or epitope) on the protein; in other words the antibody is recognizing and binding to a specific protein structure rather than to proteins in general. For example, if an antibody is specific for epitope “A,” the presence of a protein containing epitope “A” (or free, unlabelled “A”) in a reaction containing labeled “A” and the antibody will reduce the amount of labeled “A” bound to the antibody.

“Non-specific binding” and “background binding” when used in reference to the interaction of an antibody and a protein or peptide means an interaction that is not dependent on the presence of a particular structure (i.e., the antibody is binding to proteins in general rather that a particular structure such as an epitope).

“Label,” “marker” and “reporter” means any atom or molecule that can be used to provide a detectable (preferably quantifiable) signal. Labels may provide signals detectable by fluorescence, radioactivity, colorimetry, gravimetry, X-ray diffraction or absorption, magnetism, enzymatic activity, and the like. A label may be a charged moiety (positive or negative charge) or alternatively, may be charge neutral.

“Instructions for using said kit” refers to instructions for using the reagents contained in the kit including but not limited to instructions for the detection of analyte in a sample from a subject. In some embodiments, the instructions further comprise the statement of intended use required by the U.S. Food and Drug Administration (FDA) in labeling in vitro diagnostic products.

“Subject” means any animal (e.g., a mammal), including, but not limited to, humans, non-human primates, rodents, and the like, which is to be the recipient of a particular diagnostic test or treatment. Typically, the terms “subject” and “patient” are used interchangeably herein in reference to a human subject.

“Non-human animals” means all non-human animals including, but are not limited to, vertebrates such as rodents, non-human primates, ovines, bovines, ruminants, lagomorphs, porcines, caprines, equines, canines, felines, aves, etc.

“Amino acid sequence” and terms such as “polypeptide” or “protein” are not meant to limit the amino acid sequence to the complete, native amino acid sequence associated with the recited protein molecule.

“Humidity chamber” means a closed chamber at room temperature with >50% relative humidity, preferably with >85% relative humidity.

“Solid surface” means any solid surface suitable for the attachment of biological molecules and the performance of molecular interaction assays. Surfaces may be made of any suitable material (e.g., including, but not limited to, metal, glass, and plastic) and may be modified with coatings (e.g., metals or polymers).

“Substrate” refers to any material with a surface that may be coated with a film.

“Coated with a film” in regard to a substrate mean a situation where at least a portion of a substrate surface has a film arrayed on it (e.g. through covalent or non-covalent attachment).

“Microarray” means a solid surface comprising a plurality of addressed biological macromolecules (e.g., nucleic acids or antibodies). The location of each of the macromolecules in the microarray is known, so as to allow for identification of the samples following analysis.

“Array of first proteins” means a microarray of polypeptides on a solid support.

“Biological macromolecule” means large molecules (e.g., polymers) typically found in living organisms. Examples include, but are not limited to, proteins, nucleic acids, lipids, and carbohydrates.

“Ligand” means any biological species, such as, for example, an antigen, an antigen fragment, a peptide, an antibody, an antibody fragment, a hapten, a nucleic acid, a nucleic acid fragment, a hormone or a vitamin that interacts specifically or non-specifically with a receptor.

“Receptor” means a non-protein or a protein component that binds specifically or non-specifically to a molecule. Examples of receptors include, but are not limited to cell surface receptors, antibodies, binding proteins, binding fragments, avidin, non-protein templates and biomimetic receptors. Depending on the molecular interaction, the same molecule can act as a receptor in one reaction and as a ligand in a separate reaction.

“Target molecule” means a molecule in a sample to be detected and includes the use of a target molecule to detect the presence, absence or quantity of another molecule. Examples of target molecules include, but are not limited to, oligonucleotides (e.g. containing a particular DNA binding domain recognition sequence), viruses, polypeptides, antibodies, naturally occurring drugs, synthetic drugs, pollutants, allergens, affector molecules, growth factors, chemokines, cytokines, and lymphokines. “Non-target molecule” means a molecule that interacts non-specifically or weakly with another known molecule.

“Binding partners” means two molecules (e.g., proteins) that are capable of, or suspected of being capable of, physically interacting with each other. As used herein, the terms “first binding partner” and “second binding partner” refer to two binding partners that are capable of, or suspected of being capable of, physically interacting with each other.

The term “wherein said second binding partner is capable of interacting with said first binding partner” refers to first and second binding partners that are known, or are suspected of being able to interact. The interaction may be any covalent or non-covalent (e.g., hydrophobic or hydrogen bond) interaction.

“Signal” means any detectable effect, such as would be caused or provided by an assay reaction. For example, in some embodiments of the present invention, signals are SPR or fluorescent signals. In other embodiments, the presence of an RNA synthesized from a gene of interest is the signal.

“Gene” means a nucleic acid (e.g., DNA) sequence that comprises coding sequences necessary for the production of a polypeptide, RNA (e.g., including but not limited to, mRNA, tRNA and rRNA) or precursor (e.g., precursors). The polypeptide, RNA, or precursor can be encoded by a full length coding sequence or by any portion of the coding sequence so long as the desired activity or functional properties (e.g., enzymatic activity, ligand binding, signal transduction, etc.) of the full-length or fragment are retained. The term also encompasses the coding region of a structural gene and the including sequences located adjacent to the coding region on both the 5′ and 3′ ends for a distance of about 1 kb on either end such that the gene corresponds to the length of the full-length mRNA. The sequences that are located 5′ of the coding region and which are present on the mRNA are referred to as 5′ untranslated sequences. The sequences that are located 3′ or downstream of the coding region and that are present on the mRNA are referred to as 3′ untranslated sequences. The term “gene” encompasses both cDNA and genomic forms of a gene. A genomic form or clone of a gene contains the coding region interrupted with non-coding sequences termed “introns” or “intervening regions” or “intervening sequences.” Introns are segments of a gene that are transcribed into nuclear RNA (hnRNA); introns may contain regulatory elements such as enhancers. Introns are removed or “spliced out” from the nuclear or primary transcript; introns therefore are absent in the messenger RNA (mRNA) transcript. The mRNA functions during translation to specify the sequence or order of amino acids in a nascent polypeptide.

“Amino acid sequence” means an amino acid sequence of a naturally occurring protein molecule, “amino acid sequence” and like terms, such as “polypeptide” or “protein” are not meant to limit the amino acid sequence to the complete, native amino acid sequence associated with the recited protein molecule.

“Hydrophilic membrane,” and “hydrophilic section” mean any material that is wettable with water, and includes but is not limited to a film, a coating, a segregated section of a larger substrate, a composition that is wettable with water; a composition that when dried is wettable with water; a solution that is wettable with water; a solution that when dried is wettable with water; membranes that comprise one or a plurality of components containing hydrophilic material, such as nitrocellulose, regenerated cellulose or polysulfone, which is hydrophilized with polyvinylpyrrolidone (PVP). Additional suitable membrane materials are polyacrylonitrile, cellulose fibers (for example, as available under the trade designation Cuprophan from Akzo, Netherlands), cellulose acetate, and the like. As alternatives to membranes already comprising hydrophilic material, hydrophobic membranes can also be used if they have been made hydrophilic with hydrophilizing agents, which can be washed out, such as myristyl alcohol or with a water/ethanol mixture.

“Segregated membrane” means a membrane that is set apart or separated from another membrane.

### Generation of a Solid Surface for the Quantitative Detection of Molecular Interactions:

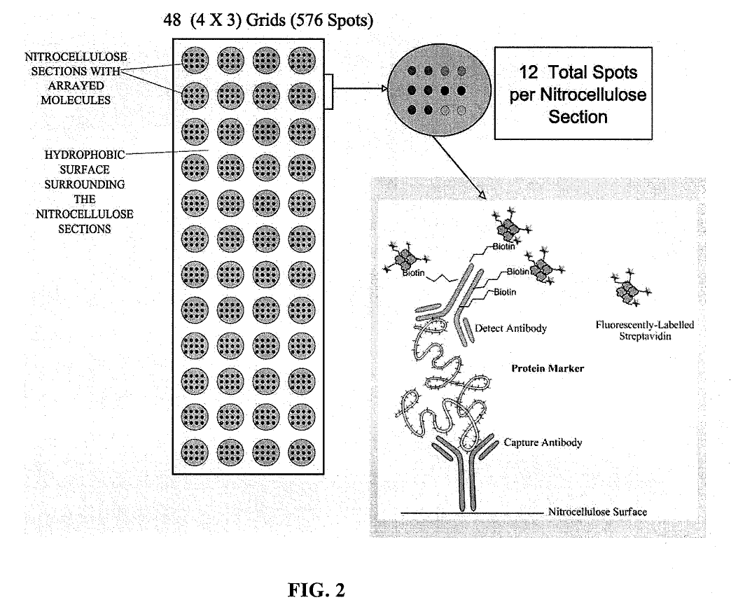

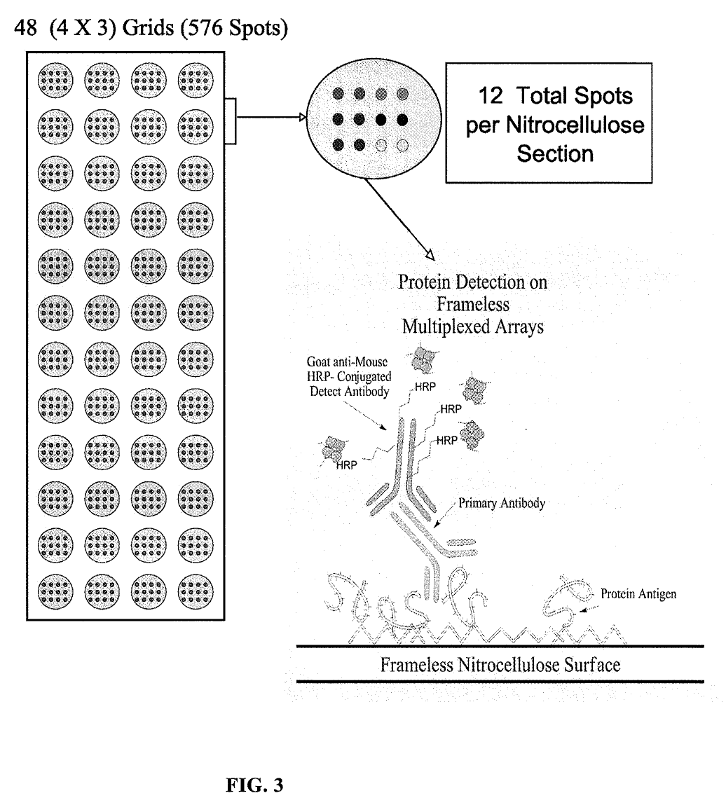

A significant challenge in the detection of molecular interactions with microarrays is to find a method that is both high throughput and utilizes multiplexed assays. In one aspect, the present invention provides a method for utilizing a solid surface comprising hydrophilic sections to produce tens of thousands of detection data points rapidly and efficiently (FIG. 2 and FIG. 3). The method comprises arraying molecules on a hydrophilic membrane, which is separated by hydrophobic regions, thereby eliminating the need for a well-framer to separate the added samples during the assay. The method further comprises: performing an assay to measure protein interactions on molecules that have been arrayed on isolated hydrophilic membranes, wherein the isolated hydrophilic membranes are located on a hydrophobic surface.

1. Solid Surface

A solid surface of the present invention comprises a hydrophobic surface. The solid surface includes but is not limited to the use of supports comprising glass, cellulose acetate, a metal, polypropylene, teflon, polyethylene, polyester, polycarbonate, polyethylene terephthalate, polyvinyl, polystyrene, and ceramics. Glass in the meaning of the invention comprises materials in amorphous, non-crystalline solid state, i.e., the glassy state in the meaning of the invention can be regarded as frozen, subcooled liquid or melt. Thus, glass materials are inorganic or organic, mostly oxide melted products converted into a solid state by an introduction process without crystallization of the melt phase components. Crystals, melts, and subcooled melts are also to be regarded as glass materials in the meaning of the invention. For example, glass materials can be flat glass, container glass, commercial glass, laboratory glass, lead glass, fiber glass, optical fiber glass, and others. It is also possible to use glass materials free of silicate, e.g., phosphate glass materials. However, the nature of the second support can be such that optical glass, i.e., glass material having a specific optical refractory index is used.

Metals also include metallic glasses, i.e., materials being in a metastable, largely amorphous state. Polymers having metallic conductivity are also included in the meaning of the invention. Polypropylenes in the meaning of the invention are thermoplastic polymers of propylene. Polypropylenes are remarkable particularly for their high hardness, resilience, rigidity, and heat resistance. Teflon is a polytetrafluoroethylene, which advantageously has good thermoplastic properties. Polyethylenes are completely inert when exposed to water, alkaline solutions, salt solutions and inorganic acids. For example, supports comprising polyethylenes have a very low water vapor permeability.

Polyesters are compounds produced by ring-opening polymerization of lactones or by polycondensation of hydroxycarboxylic acids or of diols and dicarboxylic acids or dicarboxylic acid derivatives. Polyesters also comprise polyester resins, polyester imides, polyester rubbers, polyesterpolyols, and polyesterpolyurethanes. Polyesters are thermoplastics and have distinct material character. They have high thermal stability and can be processed into alloys with metals such as copper, aluminum and magnesium. Ceramics is a collective term for an especially inorganic class of materials predominantly consisting of non-metallic compounds and elements and particularly comprising more than 30% by volume of crystalline materials. Various ceramics or ceramic materials include but are not limited to pottery, earthenware crockery, split wall tiles, laboratory porcelain, crockery porcelain, bone china, aluminum oxide ceramics, permanent magnet materials, silica bricks, and magnesia bricks can be concerned. Clay-ceramic materials are classified in coarse and fine materials, with fine clay-ceramic materials comprising earthenware, stoneware and porcelain.

2. Hydrophobic Surface

The solid surface can comprise a hydrophobic surface or can be treated with a solution to create a hydrophobic surface. Any solution or compound that creates a hydrophobic surface when applied to the solid surface can be used including but not limited to methyl and octyl derivates, reactive epoxides and epoxy adhesives. The solution or compound can be applied to the solid surface in any manner that creates the hydrophobic surface including but not limited to dipping the solid substrate into the solution or compound, spraying the solution onto the solid substrate, spreading the compound onto the solid substrate, and pippeting the solution on the solid substrate.

3. Hydrophilic Membrane

Absorptive hydrophilic membranous materials are affixed to the solid surface comprising a hydrophobic surface. The isolated hydrophilic membranes can be affixed to the solid surface and used without the need for frames (well framers). The hydrophobic area between the hydrophilic membrane demonstrates strong protein binding capacity, thus if sample leaches off a hydrophilic section, the protein will not contaminate an adjacent section. The absorptive hydrophilic membranes are designed so that as the analyte-containing samples are slowly dispensed, they are absorbed by the hydrophilic sections in real time, typically in a few seconds.

Hydrophilic membranes include but are not limited to nitrocellulose, polyvinylidene difluoride (PVDF), cellulose acetate, organic cellulose esters (also know as gun cotton), cellulose mixed esters, polytetrafluoroethylene (PTFE), polyamide, regenerated cellulose, polycarbonate, polyester, polyvinyl, polysulfone, polyacrylamide, agarose, nylon, polyprene, and mixtures of nitrocellulose and cellulose acetate. Membranes requiring pre-wetting as well as membranes that do not require pre-wetting may be used.

Nitrocelluloses are inorganic cellulose esters. Any type of nitrocellulose can be used including but not limited to white, transparent, opaque, translucent, nitrocellulose in powder form, and nitrocellulose in liquid form. Any size or shape of nitrocellulose can be used. White nitrocellulose or transparent nitrocellulose can be used or a combination of white and transparent. Protran® is a nitrocellulose membrane commercially available from Whatman. Westran S is made of PVDF is also available from Whatman. The nitrocellulose may be obtained in a powder form and then dissolved in the appropriate solution or the nitrocellulose may be obtained already in solution.

Solvents can be used for dissolving the hydrophilic membrane including but not limited to nitrocellulose and compositions of nitrocellulose and cellulose acetate. True (or active solvents) can be used and typically dissolve nitrocellulose at room temperature. These include but are not limited to ketones (acetone, methyl ethyl ketone, methyl isobutyl ketone), esters (ethyl acetate, butyl acetate, methoxy propyl acetate) and glycol ethers (methyl glycol ether, ethyl glycol ether, isopropyl glycol ether). Latent solvents also can be used to dissolve the hydrophilic membrane. In general, latent solvents cannot dissolve nitrocellulose at room temperature. When mixed with some true solvents or certain non-solvents they become capable of dissolving nitrocellulose. Examples include but are not limited to alcohols (ethanol, isopropanol, and butanol) and ethers (diethyl ether). The judicious selection of solvents for creating nitrocellulose surfaces also depends on the solubility of nitrocellulose/cellulose acetate mixtures, which are a common formulation used in membranes and surface coatings.

In yet another embodiment, segregated membranes can be coupled to a substrate. In still another embodiment, segregated membranes can comprise a composition comprising nitrocellulose. In yet another embodiment, the composition can comprise nitrocellulose, cellulose acetate and a solvent. In still another embodiment, the composition can comprise a single solvent or more than one solvent. In another embodiment, the solvent can be selected from the group consisting of acetone, ethanol, amyl acetate, butanol and more than one solvent. In yet another embodiment, the composition comprises the solvents acetone, ethanol and butanol. In still another embodiment, the solvents acetone, butanol and ethanol comprise greater than 80% of the solvent.

In yet another embodiment, any number of segregated membranes can be coupled to a substrate including but not limited to 2-7, 8, 9-11, 12, 13-15, 16, 17-23, 24, 25-35, 36, 37-47, 48, 49-95, 96, 97-383, 384, 385-1535, 1536, 1537-6133, 6144, and greater than 6144. In one embodiment, 96 membranes can be coupled to the substrate in an 8×12 grid, with about 9 millimeters apart. In another embodiment, 384 membranes can be coupled to a substrate in a 16×24 grid, with 4.5 millimeters apart. In still another embodiment, 1536 membranes can be coupled to a substrate in a 32×48 grid, with 2.25 millimeters apart.

In yet another embodiment, each membrane can comprise any area adequate for the task including but not limited to 0.25-0.5 square microns, 0.5-1.0 square microns, 1.0-1.5 square microns, 1.5-2.0 square microns, 2.0-2.5 square microns, 2.5-5.0 square microns, 5-10 square microns, 10-20 square microns, 20-40 square microns, 40-100 square microns, 0.1-0.5 square millimeters, 0.5-1 square millimeters, 1-5 square millimeters, 5-10 square millimeters, 10-15 square millimeters, 15-20 square millimeters, 20-25 square millimeters, 25-50 square millimeters, 50-100 square millimeters, 100-200 square millimeters, and greater than 200 square millimeters. In still yet another embodiment, the area can be selected from the group consisting of 1, 7, and 28 square millimeters.

In another embodiment, each membrane can be any size appropriate for the task including but not limited to a circle, a square, a rectangle, a triangle, an octagon, oval, pentagon, hexagon, parallelogram, rhombus, kite, and trapezium. In another embodiment, the array can comprise can comprise membranes coupled to the substrate of all the same shape and size, the array can comprise membranes of coupled to the substrate of more than one shape and the array can comprise membranes coupled to the substrate of more than one size.

In still another embodiment, the present invention relates to segregated membranes, which are coupled to a substrate, comprising a composition, wherein said composition is formulated to maintain an applied fluid within the perimeter of the membrane. In another embodiment, the present invention relates to a composition formulated to maintain a fluid within the perimeter of a membrane for a period of time selected from the group consisting of 0.1-0.5, 0.51-1.0, 1.1-2.0, 2.1-4.0, 4.1-6.0, 6.1-8, 8.1-10, 10.1-12, 12.1-16, 16.1-20, 20.1-24, 24.1-30, 30.1-36, 36.1-48, 48.1-54, 54.1-60, 60.1-72, 72-1-96, and 96.1-120 hours. In still yet another embodiment, the composition is formulated to allow the applied solution to cover the entire segregated membrane and maintain the applied fluid within the perimeter of the membrane.

In yet another embodiment, the composition can comprise a percentage of nitrocellulose ranging from 0.1% to 10%. In another embodiment, the composition can comprise a percentage of cellulose acetate ranging from 0.03% to 3%. In still another embodiment, the composition can comprise a solvent mixture (by volume) comprising: 48-54% acetone; 32-38% ethanol; and 10-20% n-butanol.

In still another embodiment, it is possible to use nylon, with nylon in the meaning of the invention comprising linear aliphatic polyamides. Polyvinylidene fluorides may also be used, which are thermoplastics that are easy to process and advantageously, have a high resistance when exposed to temperature and chemicals. In another embodiment, cellulose acetate may be used.

The hydrophilic membrane can be applied to the solid surface or substrate by any means that allows the hydrophilic membrane to retain its ability to interact with molecules. A formulation comprising the hydrophilic membrane and other reagents may be created to aid in the attachment of the hydrophilic membrane to the solid surface or substrate. Any formulation comprising a hydrophilic membrane may be used provided that the formulation provides stable binding to solid surfaces as well as optimal protein binding. The formulation can be obtained by dissolving the hydrophilic membrane into a solvent. Reagents useful for creation of the formulations include but are not limited to amyl acetate, methanol, acetone, ethyl acetate, ethanol, isopropanol, water, n-butanol, diethyl ether, glycerol, ethylene glycol, and cellulose acetate.

The formulations can be optimized for solubility, clarity and porosity of the hydrophilic membrane, ease of pipetting the sample, stability of the sample, and ease of scaling up production. Some parameters to consider when testing and creating the formulations are: (1) order of addition of solvents; (2) solvent ratios in the mixtures; (3) solvent concentration; (4) porosity of the final coating; (5) evenness of coating by the hydrophilic membrane; (6) ratio of one hydrophilic membrane to another hydrophilic membrane; (7) background fluorescence of the coating; and (8) stability of binding to a solid surface-even in the long term presence of aqueous detergents.

The hydrophilic membrane or formulation comprising the hydrophilic membrane can be applied to the hydrophobic surface or substrate using any method that allows for molecular interactions with the hydrophilic membrane including but not limited to pipetting, dispensing, spraying, atomizing, layering, and spreading.

In one embodiment, the formulation comprising the hydrophilic membrane can be sprayed onto the solid substrate. The formulation comprising the hydrophilic membrane can be atomized using an ultrasonic spraying device (ultrasonic nozzle). For example, a formulation can be made comprising nitrocellulose. As used herein, a nitrocellulose solution is a solution that contains between 0.1% weight/volume and 99.9% weight/volume nitrocellulose. The solution may comprise other compounds or biological macromolecules provided that the amount of nitrocellulose in the solution is in the previously defined range. The ultrasonic spraying device includes a hydrophilic membrane solution container and a spraying nozzle that is communicatively extended from the hydrophilic membrane solution container. The ultrasonic spraying nozzle atomizes the hydrophilic membrane solution in order to apply an even spray of hydrophilic membrane particles on the solid substrate. Exemplary ultrasonic spraying nozzles are commercially available from Sono-Tek Corporation (Milton, N.Y.). Exemplary Sono-Tek models include the 8700-25, 8700-35, 8700-48, 8700-48H, 8700-60, 8700-120, and 8600-6015.

In another embodiment, any type of nebulizer (atomizer) can be used to atomize the hydrophilic membrane. In some embodiments, the atomizing device comprises a nebulizer in which a hydrophilic membrane solution is guided to flow through a tube by a high-pressure stream of gas. In some embodiments, the nebulizer is air-assisted using a gas such as nitrogen in order to control a flow rate of the hydrophilic membrane particles at the nebulizer so as to control the thickness of the hydrophilic membrane film on the solid substrate.

In another embodiment, the segregated membranes can be coupled to the substrate by dispensing a composition comprising nitrocellulose. The composition can be dispensed using any machine suitable for the task including but not limited to the Nanodrop I, Nanodrop ExtY, the Nanodrop II, Nanodrop Express, the Screenmaker 96+8, and the Platemaker HTS, all available from Innovadyne Technologies (Santa Rosa, Calif.).

In another embodiment, the segregated membranes can be coupled to a plastic substrate. In yet another embodiment, the segregated membranes comprise a composition comprising nitrocellulose. In still another embodiment, the plastic substrate includes but is not limited to PEI cellulose.

In yet another embodiment, the present invention relates to a method for producing a frameless array comprising dispensing a composition comprising nitrocellulose onto a polyester film; and drying said film in a humidity chamber. In still another embodiment, the composition further comprises cellulose acetate and a solvent. In still another embodiment, the humidity chamber is greater than 60% relative humidity.

4. Attaching an Analyte on a Membrane

Any analyte or target molecule can be attached on a membrane including but not limited to a probe, an antigen, an antibody, a molecule, a small molecule inhibitor, an antibody, a monoclonal antibody, a polyclonal antibody, a fragment of an antibody, an active region of an antibody, a conserved region of an antibody, a peptide, a peptide mimetic, fragment of a protein, active region of a protein, a protein, amino acid sequence, single stranded nucleic acid, RNA, DNA, and a fragment of a gene. In yet another embodiment, any number of analytes or target molecules can be attached to each membrane including but not 1-5, 6-10, 11-15, 16-20, 21-25, 26-30, 31-40, 41-50, 51-100, and greater than 100. In still yet another embodiment, the same analyte/target molecule or a different analyte/target molecule can be attached to each membrane. In another embodiment, each membrane of the array can be arrayed with the same analyte, the same set of analytes or different analytes.

In yet another embodiment, each analyte or target molecule coupled to the membrane can have an individual area selected from the group consisting of: 1-10, 11-20, 21-30, 31-40, 41-50, 51-60, 61-70, 71-74, 75, 76-100, 101-149, 150, 151-200, 201-250, 251-300, 301-350, 351-400, 401-449, 450, 451-500, 501-749, 750, 751-1000, and greater than 1000 microns in diameter.

### Detection of Molecular Interactions:

The methods and apparatus of the present invention can be used to detect any molecule or target molecule including but not limited to a native or denatured protein, an antibody, a monoclonal antibody, a polyclonal antibody, a fragment of an antibody, an active region of an antibody, a conserved region of an antibody, a fragment of a protein, an active region of a protein, a peptide, a peptide mimetic, an amino acid sequence, a single stranded nucleic acid including but not limited to an oligonucleotide and primer, and double stranded nucleic acids. The nucleic acid that is to be analyzed can be any nucleic acid, e.g., genomic, plasmid, cosmid, yeast artificial chromosomes, artificial or man-made DNA, including unique DNA sequences, and also DNA that has been reverse transcribed from an RNA sample, such as cDNA. The nucleic acid can comprise one or more than one single nucleotide polymorphism (SNP), a mutation, or more than one mutation. Oligonucleotide probes and primers of any length can be used to detect nucleic acids.

The methods and apparatus of the present invention can be used to detect any type of molecular interaction including but not limited to antibody-antigen interactions, and can be used to identify antibodies with specific affinities. In another embodiment, the present invention can be used to determine the isotype of an antibody. The methods of the present invention can be used to detect and determine the binding kinetics of any antibody that interacts with an antigen including but not limited to an antibody that recognize a protein involved in Alzheimer's Disease, angiogenesis, autoimmune disorders, bacterial infections, breast cancer, cell cycle regulation, cancer progression, heart disease, HIV, immune disorders, kidney disease, leukemia, liver cancer, lung cancer, muscular skeletal disorders, neurodegenerative disorders, Parkinson's disease, prostate cancer, thyroid disorders and viral infections. In addition, the methods and apparatus of the present invention can be used to identify molecules that interrupt protein-antibody interactions and protein-protein interactions, including small molecule inhibitors and peptide mimetics.

In yet another embodiment, the methods of the present invention can be used to simultaneously determine the binding specificity of an analyte, the dissociation constant for the analyte and a target molecule and a dissociation constant for the analyte and a non-target molecule, isotyping an antibody, performing an antigen array and a sandwich ELISA at the same time, and determining the concentration of an antibody. A single frameless microarray can be used to determine any number of binding characterizations including specificity, dissociation constants, equilibrium binding, isotyping, and determining the concentration of an analyte in a sample. Table 1 provides an exemplary list of antibodies that could be assayed using the methods of the present invention.

TABLE 1
An illustrative list of antibodies that can be assayed
using the methods of the present invention

| Antibody | Function | Antibody | Function | Antibody | Function |
|---|---|---|---|---|---|
| Androgen | Androgenic | GLUT-1 | Glucose | FLK-1 | Growth of |
| Receptor | Receptor | | receptor | | endothelial cells |
| BrdU | Proliferation | Id-1 | cell growth, | Glucuocorticoid | Hormonal |
| | | | senescence, | receptor Ab | Regulation |
| | | | differentiation | | |
| BRCA-1/ | Breast | Ki-67 | Proliferation | GFP | Monitoring gene |
| BRCA-2 | Tissue | | | | expression |
| Antibody | | | | | |
| CD3 | T-cell | Laminin | Basement | PCNA | Proliferation |
| | | | membrane | | |
| CD31 | Endothelial | Neurofilamanent | Neurofilament | PROX-1 | Lymphatic |
| | cells | | | | endothelia |
| CD34 | Capillary | P-Histone | Sex body, | S.M.A. | Smooth muscle |
| | endothelial | H2AX | DNA damage | | actin |
| | cells | | | | |
| CD45R/B220 | B-cells | P-Histone | Mitosis (cell | Smad4 | Smad-4 gene |
| | | H3 | proliferation) | | |
| C-Kit | Germ cells | P- | Protein | SHH | Sonic hedgehog |
| | | Ribosomal | synthesis | | |
| | | S6 Protein | | | |
| Cleaved | Apoptosis | P-21 | Cyclin | Survivin | Apoptosis inhibitor |
| Caspase-3 | | | inhibitor | | |
| Cyclin | Cell cycle | P-27 | Cell cycle | Ter 119 | Erythroid cells |
| D1 | | | inhibitor | | |
| Desmin | Desmin | P-53 | P53 gene | IFN-alpha, beta, | Immune system |
| | | | | gamma | |
| Estrogen | Hormonal | P-16 | Cyclin | Interleukins 1, | Immune system |
| Receptor | Regulation | | dependent | 2, 12, | |
| Ab | | | kinase | | |
| E- | Epithelial | P-AKT | Cell survival, | Thyroid | Hormonal |
| cadherin | junction | | cell cycle | receptor | regulation |
| EMA-1 | PGC | Cleaved | Apoptosis | | |
| | | PARP | | | |

The methods and apparatus of the present invention can be used to detect molecules in any type of sample including but not limited to a sample from a bacterium, fungus, virus, prion, plant, protozoan, animal or human source. The sample can be obtained from a cell, a cell extract, a plant extract, lectin, tissue, organ, blood sample, serum sample, plasma sample, urine sample, spinal fluid, amniotic fluid, chorionic villi, sputum, respiratory exudates, lymphatic fluid, semen, an embryo, vaginal secretion, ascitic fluid, saliva, mucosa secretion, peritoneal fluid, fecal sample, or body exudates. The sample can be purified or can represent a lysate at any state of purification. The sample can be a whole cell lysate including but not limited to NIH293, A-20, HeLa, HepG2, Jurkat, PC-3, SW480, T24, U937, and WI-38 whole cell lysate. The sample can be a subcellular fraction cell lysate including but not limited to a cytoplasmic protein lysate, a membrane protein lysate, and a nuclear protein lysate. In addition, the sample can be a cell extract at any stage of purification including but not limited to an extract that represent merely disrupting the cell, an extract that involves one purification step, and an extract that involves more than one purification step. The cell extract can be obtained from specific types of cells including cancer cells, hybridomas, liver, kidney, bladder, ovary, adipose tissue, lymph node, cervix, pancreas, brain, lung, heart, spleen, thyroid, breast, colon, and prostate cells.

In another embodiments, the sample can be applied in any appropriate volume including but not limited to 0.01, 0.1, 0.25, 0.4, 0.5, 1, 2, 3, 4, 5, 6-10, 11-20, 21-30, 31-50, 51-100, 101-200, 201-300, 301-500, 501-1000 microliters. One of ordinary skill in the art will understand that the appropriate sample volume to be applied is proportional to the size of the membrane. In still yet another embodiment, the sample is applied in a volume to cover each segregated membrane.

In another embodiment, the methods and apparatus of the present invention can be used to detect any analyte including but not limited to a probe, an antigen, a molecule, an antibody, a monoclonal antibody, a polyclonal antibody, a fragment of an antibody, an active region of an antibody, a conserved region of an antibody, a small molecule inhibitor, a protein, a fragment of a protein, an active region of a protein, a peptide, a peptide mimetic, and an amino acid sequence, RNA, DNA, a single stranded nucleic acid including but not limited to an oligonucleotide and primer, and double stranded nucleic acids. The nucleic acid that is to be analyzed can be any nucleic acid, e.g., genomic, plasmid, cosmid, yeast artificial chromosomes, artificial or man-made DNA, including unique DNA sequences, and also DNA that has been reverse transcribed from an RNA sample, such as cDNA. The nucleic acid can comprise a single nucleotide polymorphism (SNP), a mutation, or more than one mutation. Oligonucleotide probes and primers of any length can be used to detect nucleic acids.

In another embodiment, the method of detection can be any suitable method including but not limited to calorimetric, fluorescent, near infrared fluorescent, ultraviolet spectrometry, silver deposition, chemiluminescent, ELISA, and electrochemiluminescent.

### Selection of High Affinity Reagents

The affinity of two bio-molecules often is described by the dissociation constant, the Kd. If the Kd is known for two binding molecules, it provides a prediction as to how molecules could function in a protein detection assay. If the Kd is in the appropriate range (fM, pM, nM, or uM) for detection, further investigation as to other assay parameters, such as specificity, range, linearity, stability, etc could be warranted. Although, the appropriate Kd can vary between molecules and environmental context. Screening for the right dissociation constant early in the assay development process is important but still very challenging. There is a need for more simple, robust, and quantitative methods to measure equilibrium rate constants in a high throughput, multiplexed microarray format. The methods of the present invention fulfill this need.

In one embodiment, the method of the present invention comprises applying a sample containing an analyte to a frameless microarray and performing any number of assays on the same microarray to characterize the analyte including but not limited to 1, 2, 3, 4, 5, 6, 7, 8, 9, 10, 11-20, 21-30, 31-40, 41-50, 51-100, and greater than 100 assays.

For a biochemical reaction at equilibrium, a Receptor (R) binds reversibly with the Ligand (L) to form a complex (Receptor·Ligand). Kₒₙ is the forward (association) rate constant and K_{off} is the reverse (dissociation) rate constant (Equation 1).

[Receptor]+[Ligand]⇄[Receptor·Ligand] Equation 1.

Kₒₙ is the forward rate constant and K_{off} is the reverse rate constant

Binding occurs in reaction when the Receptor and Ligand interact in the correct orientation and with enough energy. The association rate (number of binding events per unit time) equals [Ligand][Receptor]·Kₒₙ. Kₒₙ typically is measured in units of M⁻¹min⁻¹. Once binding has occurred, the ligand and receptor remain bound for a period of time influenced by the affinity of the Ligand and Receptor for one another. The rate of dissociation (number of dissociation events per unit time) equals [Ligand−Receptor]·K_{off}. K_{off} is in units of time, typically min⁻¹. Equilibrium occurs when the forward and reverse reactions are equal (Equation 2).

At equilibrium [Ligand]·[Receptor]Kₒₙ=[Ligand·Receptor]K_{off} Equation 2.

The Kd, expressed in molarity, is a ratio of the off rate to the on rate. (Equation 3). A small Kd means the receptor has a high affinity for the ligand while a large Kd means the receptor has a low affinity for the ligand. The term Receptor (R) and Ligand (L) are commonly used as representative terms in biochemical equilibrium binding. For example, the terms can refer to actual protein receptors and their cognate ligands, to antibodies and their binding targets, to peptides binding to other small or large molecules, or carbohydrates binding to proteins. There is no exact correlation of molecular size as to which molecule is referred to as the Receptor or Ligand.

Kd=K_{off}/Kₒₙ=[L]·[R]/[LR] Equation 3.

It is possible to predict the fractional receptor occupancy at equilibrium as a function of the Ligand concentration and the dissociation constant. It is also possible to predict the fractional receptor occupancy as a function of the Kd and the Ligand concentration.

Fractional Occupancy=[Ligand·Receptor]/[Receptor]ₜₒₜₐₗ Equation 4.

Fractional Occupancy=[Ligand·Receptor]/([Receptor]+[Ligand−Receptor]) Equation 5.

Fractional Occupancy=[Ligand]/([Ligand]+Kd) Equation 6.

Fractional occupancy and its relationship to the Kd is critical in assay design. If the detection level is limiting because of the law of mass action (the Kd), it is likely that optimization (except possibly by inducing multivalent binding) will provide only nominal assay improvement. Table 2 shows the fractional occupancy as it relates the ligand concentration, receptor concentration, and the Kd. It is based on Equation 7 where B is the percent bound and T is for total.

$$B = \frac{\begin{matrix}{L}_{T} + {K}_{d} + {R}_{T} - \\ \sqrt{[ {( {L}_{T} + {K}_{d} + {R}_{T} )}^{2} - 4 {L}_{T} {R}_{T} ]}\end{matrix}}{2} . \qquad Equation 7$$

TABLE 2
Fractional Occupancy Depends on the Kd and the Ligand and
Receptor Concentrations.

| Ligand | Receptor | | |
|---|---|---|---|
| Concentration | Concentration | | |
| Relative to Kd | Relative to Kd | % Ligand Bound | % Receptor at |
| [L]/Kd | [R/Kd] | at Equilibrium | Equilibrium |
| 0.01 | 0.01 | 1 | 1 |
| 0.01 | 0.1 | 9 | 0.5 |
| 0.01 | 1 | 50 | 0.1 |
| 0.01 | 10 | 91 | 0.09 |
| 0.01 | 50 | 98 | 0.02 |
| 0.1 | 0.01 | 0.9 | 9 |
| 0.1 | 0.1 | 8.4 | 8.4 |
| 0.1 | 1 | 49 | 4.9 |
| 0.1 | 10 | 91 | .9 |
| 0.1 | 50 | 98 | .2 |
| 1 | 0.01 | 0.1 | 50 |
| 1 | 0.1 | 5 | 49 |
| 1 | 1 | 38 | 38 |
| 1 | 10 | 90 | 9 |
| 1 | 50 | 98 | 2 |
| 10 | 0.01 | .1 | 91 |
| 10 | 0.1 | .9 | 90.8 |
| 10 | 1 | 9 | 90.1 |
| 10 | 10 | 73 | 73 |
| 10 | 50 | 98 | 19.5 |

The above-table demonstrates the importance of having the receptor concentration at or above the Kd in order to detect low levels of analytes. A lower Kd (higher affinity) aids in the development of an assay with the appropriate sensitivity and range.

In addition, the above-data demonstrate the significance of determining the Kd of a binding reaction early in the assay development process. This invention relates to methods and materials for determining biochemical affinity measurements in a rapid and efficient manner, using frameless, multiplexed, miniaturized, arrays. The methods of the present invention can be used to determine the equilibrium binding data between a single molecule and several other molecules.

### Kits:

The methods of the invention are most conveniently practiced by providing the reagents used in the methods in the form of kits. A kit preferably contains one or more of the following components: written instructions for the use of the kit, appropriate buffers, salts, a solid substrate, a hydrophobic solution or compound, such as an epoxy, and a hydrophilic membrane, such as nitrocellulose, detergents, and if desired, water of the appropriate purity, confined in separate containers or packages, such components allowing the user of the kit to create a solid surface useful for quantitative detection of molecular interactions. The kit may also contain a frameless hydrophilic membrane multiplexed array in 96, 384, 1,536, or 3,436 format with the antigens arrayed. The antigens can be arrayed once, in duplicate, triplicate or quadruplicate or any format that is desired. The kit may also contain antibodies, labeled antibodies, serial dilutions of antibodies, cells, extracts, serial dilution of antigens, oligonucleotides, primers, controls and other useful reagents for detection of molecules. The primers that are provided with the kit will vary, depending upon the purpose of the kit and the DNA that is desired to be tested using the kit.

A kit also can be designed to detect a desired or variety of molecular interactions, especially those associated with an undesired condition or disease. For example, one kit can comprise, among other components, a set or sets of antibodies to detect proteins associated with breast cancer. Another kit can comprise, among other components, a set or sets of antibodies to detect colon cancer. Still, another kit can comprise, among other components, a set or sets of primers for genes associated with a predisposition to develop heart disease.

The following examples illustrate various embodiments of the invention, but should not be construed to limit the scope of the invention in any manner.

### Specific Embodiments

### Example 1

### Preparation of Surfaces Containing Dots of Nitrocellulose Surrounded by Hydrophobic Areas

Standard microscope slides were purchased from (Fisher Scientific, Chicago, Ill.) and cleaned by autoclaving 45 minutes at (240° F.) in a 1-5% solution of Cascade (Proctor and Gamble) detergent. The slides were rinsed multiple times in deionized water to remove all residual detergent and were dried in a clean sterile hood. In some cases, the slides were dried rapidly in a 300° F.-350° F. oven for 5-10 minutes. Alternatively, pre-cleaned slides are available from Erie Scientific, Portsmouth, N.H. Alternatively, custom glass slides (3.5″×5.0″) can be purchased from Erie Scientific and cleaned as described.

Polyester sheets can also be substituted for the glass slide. It may require cleaning and it does not require an epoxy pre-treatment for the nitrocellulose formulation to affix to the surface. The polyester surface is sufficiently hydrophobic so that analyte samples remain absorbed to the nitrocellulose dots and do not spread to surrounding samples. The polyester sheets also offer the advantage in that a 96 nitrocellulose dot array can be printed and then easily cut with a scissors, razor, or laser into sections to perform a smaller number of assays.

The glass slide was treated by dip coating (dipped once) in a diluted epoxy adhesive manufactured by Henkel Consumer Adhesives (Avon, Ohio). The adhesive contained silica quartz (40-60%), aliphatic amine (10-20%), benzoyl alcohol (5-10%), silica fumed (5-10%), formaldehyde polymer with toluene (5-10%), Phenol 2,4,6 tris[(dimethylamino) methyl] (5-10%), N-isotridecyloxypropyl-trimethylene diamine (1-5%), propylene glycol (1-5%), and isophoronediamine (1-5%). The epoxy adhesive was prepared as per the manufacturer's instructions and diluted 10 fold in acetone. (Fisher Scientific, Pittsburgh, Pa.). The diluted mixture was centrifuged for 20 minutes at 15000×g and the material above the silica pellet was removed and used for dip coating the slides. The slides were dipped 1-4 seconds and dried immediately in airflow of approximately 400 feet per second. The dried slides were stored at room temperature.

Alternatively, the clean slides were coated with an epoxy adhesive from Environmental Technologies, (Fields Landing, Calif.). The resin components were nonyl phenol, and polyoxyalkyleneamines and the hardener components were bisphenol A/epichlorohydrin resin and C12 and C14 alkyl glycidyl ethers. The exact concentrations of the components are considered confidential for the manufacturer, Environmental Technologies. In the preferred embodiment, equal volumes of the hardener and resin for the clear casting epoxy were mixed and diluted 16 fold in amyl acetate (Fisher Scientific, Pittsburgh, Pa.). Approximately 400 μl of the solution was pipetted to the level surface of a clean 25×75 mm glass slide. The slide was placed in a small closed container at room temperature and allowed to dry slowly over approximately 1 hour. If the coated slide was dried too rapidly, the coating was uneven and unacceptable for nitrocellulose binding. This epoxy adhesive provided an optically clear surface on the glass. The dried slides were stored at room temperature in a closed container. Other solvents such as butanol and isopropanol may be substituted for amyl acetate but the more volatile the solvent, the more tightly the drying process must be controlled in order to allow polymerization of the epoxy adhesive.

Nitrocellulose was purchase as a 10% solution in acetone from Ladd Research (Williston, Vt.). Cellulose acetate was purchased for Sigma Chemical (St. Louis, Mo.) and dissolved in acetone. A nitrocellulose mixture was prepared: 3% nitrocellulose, 0.3% cellulose acetate, with a final solvent concentration (by volume) of 51% acetone, 35% ethanol, and 14% n-butanol. To cover an entire slide, 500-600 μl was pipetted to the surface of a level slide and dried rapidly in a clean environment. For creating nitrocellulose dots in a 96 (8×12) grid on a surface (FIG. 3), approximately 14 μl of the solution was pipetted using a Beckman Biomek 2000 (Beckman Coulter, Fullerton, Calif.) pipetting station directly on to the surface. For creating a 384 well grid (24×16), approximately 1.8 μl of the solution was pipetted on to the surface.

Ethyl acetate may be substituted for the acetone as it is less volatile and more easily pipetted.

### Example 2

### Determination of Dissociation Constant Using Frameless, Multiplexed Microarrays

Printing of Antigen Proteins

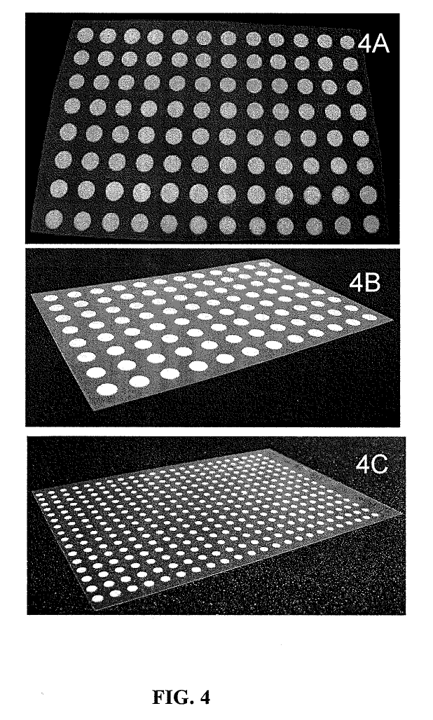

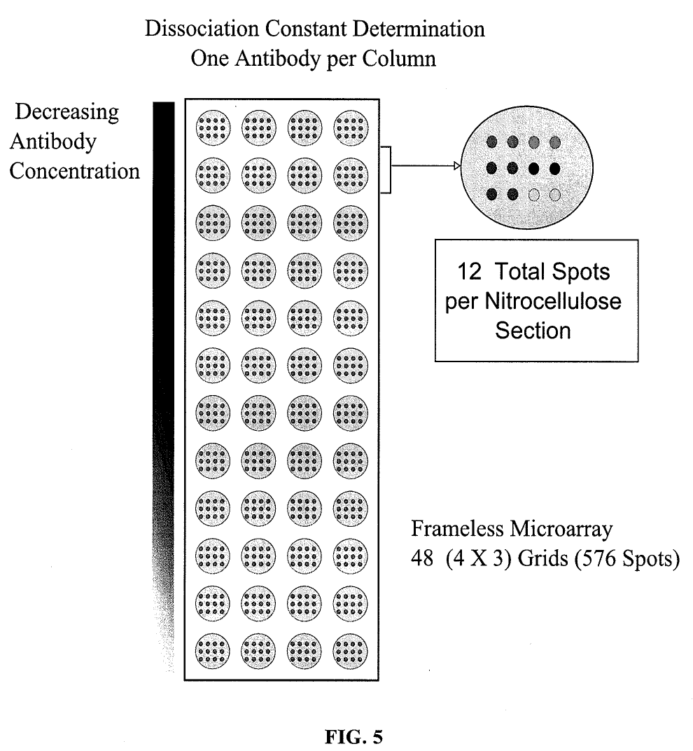

The experimental design is shown schematically in FIG. 4 and FIG. 5. Ninety six nitrocellulose dots were prepared on clear 3 ml polyester as described in Example 1 and illustrated in FIG. 4B. Three antigens, interferon (IFN)-gamma (Ciba-Geigy, Basel, Switzerland), ovalbumin (Sigma Chemical, St. Louis, Mo.), and mouse immunoglobulin (IgG) (Equitech Bio, Kerrville, Tex.), were printed or “spotted” in quadruplicate at 200 μg/ml in phosphate buffered saline (PBS) on each of the 96 nitrocellulose areas (dots). Thus, each nitrocellulose area (dot) contained twelve spots. The spots were printed in a BioRad Calligrapher and allowed to dry after printing in high humidity for 15 minutes. Each nitrocellulose area (dot) was blocked with 14 μl of the Pierce non-protein block (Pierce Biochemicals, Rockford, Ill.). The nitrocellulose areas (dots) were incubated for 1 hour and then the excess was removed by aspirating the excess solution. The dots then were dried. Alternatively, the array can be blocked by immersion of the entire array in the blocking agent.

Addition of Antibody Dilution Series

Four purified monoclonal antibodies were used: one was an anti-ovalbumin antibody and the other three were different anti-IFN-gamma antibodies (generously supplied by Randy Wagner). For each antibody, a panel of twelve serial dilutions was created. Each dilution series started with full strength purified antibody and was diluted 1 in 7 twelve times into PBS+0.1% Tween-20 (PBST). Each dilution was applied to two arrayed nitrocellulose dots so the assay was done in duplicate. The samples were applied to the arrayed nitrocellulose dots using a Beckman Biomek 2000 (Beckman Coulter, Fullerton, Calif.). The array was incubated in a high humidity chamber for 1 hour. A summary of the antibody dilutions (with all concentration in pmoles/L of antibody in PBST buffer) on the nitrocellulose dots is provided in Table 3. Applied samples can be maintained in a high humidity environment for up to several days without evaporation.

TABLE 3
Summary of the concentration of antibody in each serial dilution as
applied to the nitrocellulose dot

| Serial | | IFN | IFN | IFN |
|---|---|---|---|---|
| Dilu- | Ova | Ab1 | Ab2 | Ab3 |
| tion | Ab (pmoles/L) | (pmoles/L) | (pmoles/L) | (pmoles/L) |
| 12 | 0.0013 | 0.001 | 0.0019 | 0.0029 |
| 11 | 0.0093 | 0.0068 | 0.0133 | 0.0203 |
| 10 | 0.065 | 0.047 | 0.093 | 0.142 |
| 9 | 0.458 | 0.332 | 0.653 | 0.994 |
| 8 | 3.21 | 2.32 | 4.57 | 6.96 |
| 7 | 22.4 | 16.3 | 32 | 48.7 |
| 6 | 157 | 114 | 224 | 341 |
| 5 | 1,100 | 797 | 1,567 | 2,386 |
| 4 | 7,697 | 5,580 | 10,968 | 16,702 |
| 3 | 53,878 | 39,061 | 76,776 | 116,914 |
| 2 | 377,143 | 273,429 | 537,429 | 818,400 |
| 1 | 2,640,000 | 1,914,000 | 3,762,000 | 5,728,800 |

Addition of Goat Anti-Mouse IgG Labeled with HRP and the TMB Substrate

The goat anti-mouse IgG labeled with horseradish peroxidase (HRP) (Santa Cruz Biotechnology, Inc., Santa Cruz, Calif.) antibody was diluted 1:1000 in PBST and the entire immersed array was incubated for one hour while shaking gently. It was washed three times with PBST over the course of 30 minutes and rinsed several times in deionized, nanopure water. The array was covered with 10-20 mls of TMB (3,3′,5,5′-tetramethylbenzidene) substrate (Moss Inc., Pasadena, Md.). The array was incubated until the background was visible. The array was rinsed several times with deionized water to remove the excess TMB and dried in a particle free hood.

Image Capture and Analysis

The dried slide was scanned with a High Resolution scanner (Epson America, Long Beach, Calif.) at 2400 dpi in 16-bit greyscale file. The image was inverted using Photoshop Elements (Adobe Systems Inc., San Jose, Calif.) and saved as a TIFF file labeled with an additional “INVERTED.” The image was analyzed with the GenePix Pro 6.1 software (Molecular Devices, Sunnyvale, Calif.) and interpreted with Microsoft Excel spreadsheet software (Microsoft Corporation, Redmond, Wash.) and Graphpad Prism software (Graphpad Software, Inc., San Diego, Calif.).

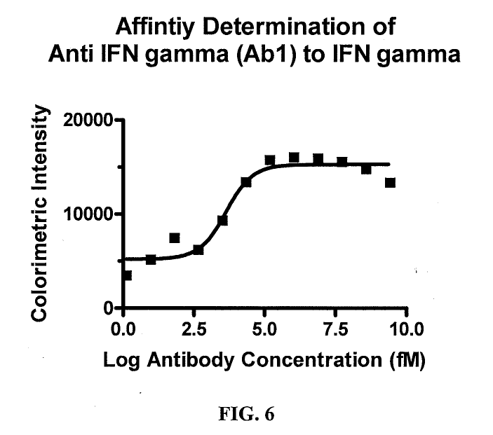

The data reported in FIGS. 6-10 were generated in the same multiplexed assay but for presentation purposes, were split into several figures. FIG. 6 is a graph reporting the equilibrium dissociation constant, Kd, for the IFN-gamma antibody (Ab1) and IFN-gamma, as measured in a frameless, multiplexed, miniaturized antigen array. Table 4 provides additional information with regard to the affinity determination for the IFN-gamma antibody (Ab1).

TABLE 4
Summary of the analytical data for the Kd of IFN-Ab1 Antibody and
IFN-gamma

| Sigmoidal dose-response Ab1 | |
|---|---|
| Best-fit values | |
| BOTTOM | 5206 |
| TOP | 15291 |
| LOGEC50 | 3.641 |
| HILLSLOPE | 0.9241 |
| EC50 (4.373 pM) | 4373 |
| Std. Error | |
| BOTTOM | 792.6 |
| TOP | 561.2 |
| LOGEC50 | 0.2338 |
| HILLSLOPE | 0.4076 |
| 95% Confidence Intervals | |
| BOTTOM | 3378 to 7034 |
| TOP | 13997 to 16585 |
| LOGEC50 | 3.102 to 4.180 |
| HILLSLOPE | −0.01590 to 1.864 |
| EC50 | 1264 to 15131 |
| Goodness of Fit | |
| Degrees of Freedom | 8 |
| R² | 0.9466 |
| Absolute Sum of Squares | 1.32E+07 |
| Data | |
| Number of X values | 12 |
| Number of Y replicates | 1 |
| Total number of values | 12 |
| Number of missing values | 0 |

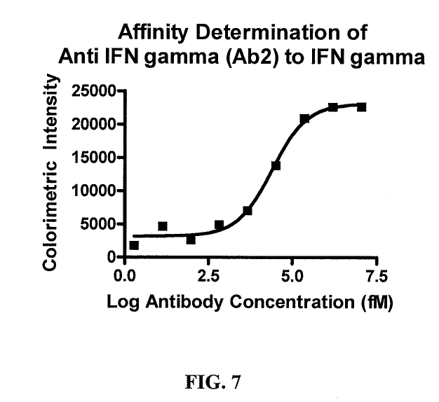

FIG. 7 is a graph reporting the equilibrium dissociation constant, Kd, for the IFN-gamma antibody (Ab2) and IFN-gamma as measured in a frameless, multiplexed, miniaturized antigen array. Table 5 provides additional information with regard to the affinity determination for the IFN-gamma antibody (Ab2).

TABLE 5
Summary of the analytical data for the Kd of IFN-gamma antibody
(Ab2) and IFN-gamma

| Sigmoidal dose-response Ab2 | |
|---|---|
| Best-fit values | |
| BOTTOM | 3182 |
| TOP | 23139 |
| LOGEC50 | 4.398 |
| HILLSLOPE | 0.8419 |
| EC50 (24.979 pM) | 24979 |
| Std. Error | |
| BOTTOM | 625.9 |
| TOP | 918.3 |
| LOGEC50 | 0.1175 |
| HILLSLOPE | 0.1726 |
| 95% Confidence Intervals | |
| BOTTOM | 1573 to 4791 |
| TOP | 20778 to 25500 |
| LOGEC50 | 4.095 to 4.700 |
| HILLSLOPE | 0.3981 to 1.286 |
| EC50 | 12456 to 50091 |
| Goodness of Fit | |
| Degrees of Freedom | 5 |
| R² | 0.9905 |
| Absolute Sum of Squares | 5.92E+06 |
| dData | |
| Number of X values | 9 |
| Number of Y replicates | 1 |
| Total number of values | 9 |
| Number of missing values | 0 |

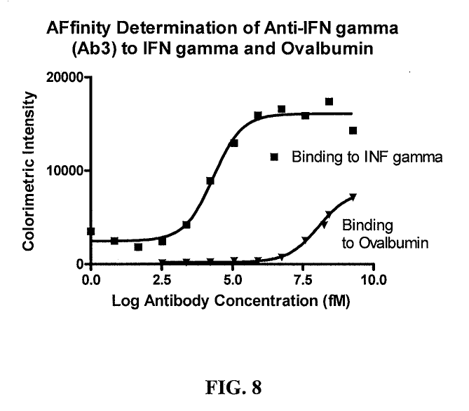

FIG. 8 is a graph reporting the equilibrium dissociation constant, Kd, for the IFN-gamma antibody (Ab3) and IFN-gamma, as measured in a frameless, multiplexed, miniaturized antigen array. Table 6 provides additional information with regard to the affinity determination for the IFN-gamma antibody (Ab3).

TABLE 6
Summary of the analytical data for the Kd of IFN-gamma antibody
(Ab3) and IFN-gamma
Sigmoidal dose-response (variable slope) Ab3

| Best-fit values | |
|---|---|
| BOTTOM | 2465 |
| TOP | 16097 |
| LOGEC50 | 4.323 |
| HILLSLOPE | 0.8547 |
| EC50 (21.054 pM for IFN gamma) | 21054 |
| EC50 (114 nM for Ovalbumin) | |
| Std. Error | |
| BOTTOM | 535.3 |
| TOP | 487.3 |
| LOGEC50 | 0.1387 |
| HILLSLOPE | 0.2074 |
| 95% Confidence Intervals | |
| BOTTOM | 1231 to 3700 |
| TOP | 14973 to 17220 |
| LOGEC50 | 4.003 to 4.643 |
| HILLSLOPE | 0.3765 to 1.333 |
| EC50 | 10078 to 43984 |
| Goodness of Fit | |
| Degrees of Freedom | 8 |
| R² | 0.9827 |
| Absolute Sum of Squares | 7.80E+06 |
| Data | |
| Number of X values | 12 |
| Number of Y replicates | 1 |
| Total number of values | 12 |
| Number of missing values | 0 |

As shown in FIG. 8, the antibody bound to both the interferon gamma as well as the ovalbumin protein that was arrayed. The dissociation constant for the ovalbumin is 5400 fold higher than the dissociation constant for the interferon gamma (21.1 pM of interferon gamma versus 114 nM for ovalbumin). The other two anti-interferon antibodies did not show measurable binding to the ovalbumin.

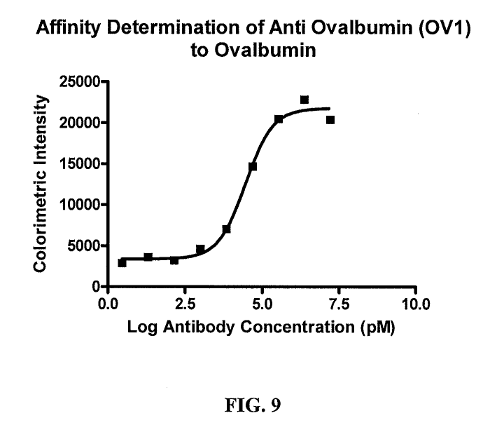

FIG. 9 is a graph reporting the equilibrium dissociation constant, Kd, for the anti-ovalbumin antibody and ovalbumin, as measured in a frameless, multiplexed, miniaturized antigen array. Table 7 provides additional information with regard to the affinity determination for the anti-ovalbumin antibody.

TABLE 7
Summary of the analytical data for the Kd of anti-ovalbumin antibody and
ovalbumin
Sigmoidal dose-response (variable slope)

| Best-fit values | |
|---|---|
| BOTTOM | 3382 |
| TOP | 21781 |
| LOGEC50 | 4.461 |
| HILLSLOPE | 0.9819 |
| EC50 (28.919 pM) | 28919 |
| Std. Error | |
| BOTTOM | 519.3 |
| TOP | 683 |
| LOGEC50 | 0.09527 |
| HILLSLOPE | 0.185 |
| 95% Confidence Intervals | |
| BOTTOM | 2047 to 4717 |
| TOP | 20025 to 23537 |
| LOGEC50 | 4.216 to 4.706 |
| HILLSLOPE | 0.5062 to 1.458 |
| EC50 | 16453 to 50829 |
| Goodness of Fit | |
| Degrees of Freedom | 5 |
| R³ | 0.9924 |
| Absolute Sum of Squares | 4.35E+06 |
| Sy.x | 932.6 |
| Data | |
| Number of X values | 12 |
| Number of Y replicates | 1 |
| Total number of values | 9 |
| Number of missing values | 3 |

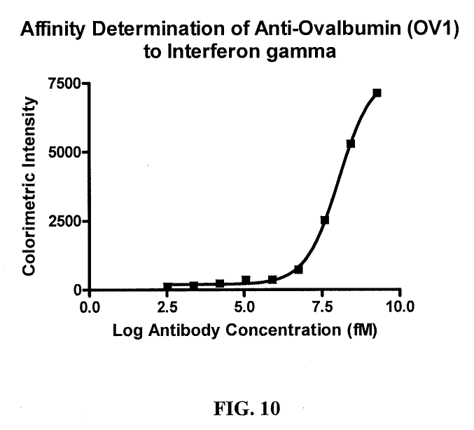

FIG. 10 is a graph reporting the equilibrium dissociation constant, Kd, for the anti-ovalbumin antibody, bound to interferon-gamma with low affinity. Table 8 provides additional information with regard to the affinity determination for the anti-ovalbumin antibody bound to interferon-gamma.

TABLE 8
Summary of the analytical data for the Kd of anti-ovalbumin and
IFN-gamma
Sigmoidal dose-response Anti-oval binding to IFNgamma

| Best-fit values | |
|---|---|
| BOTTOM | 197.7 |
| TOP | 7837 |
| LOGEC50 | 8.058 |
| HILLSLOPE | 0.8027 |
| EC50 (1.14 nM) | 1.14E+08 |
| Std. Error | |
| BOTTOM | 41.06 |
| TOP | 197.8 |
| LOGEC50 | 0.04236 |
| HILLSLOPE | 0.045 |
| 95% Confidence Intervals | |
| BOTTOM | 92.08 to 303.2 |
| TOP | 7329 to 8346 |
| LOGEC50 | 7.949 to 8.167 |
| HILLSLOPE | 0.6870 to 0.9184 |
| EC50 | 8.8928e+007 to 1.4685e+008 |
| Goodness of Fit | |
| Degrees of Freedom | 5 |
| R² | 0.9993 |
| Absolute Sum of Squares | 37091 |
| Sy.x | 86.13 |
| Data | |
| Number of X values | 9 |
| Number of Y replicates | 1 |
| Total number of values | 9 |
| Number of missing values | 0 |

### Example 3

### Determination of Antibody Binding Kinetics Using Frameless, Multiplexed Microarrays

Printing of Interferon-Gamma and Ovalbumin

Three proteins, IFN-gamma, ovalbumin, and mouse IgG, were each printed 4 times on each dot at 200 μg/ml in PBS. The polyester sheet containing the arrayed nitrocellulose dots was dried in a desiccator for one hour and then blocked for 5 hours in a non-protein block solution (Pierce Biotechnology, Rockford Ill.). The polyester sheet was washed three times (5 minutes each) with PBST (0.1% Tween) and dried in a particle-free hood.

Time Course for the Incubation of Antibodies

The IFN-gamma Ab 1 was diluted 1:100,000 and the other two IFN-gamma antibodies (IFN-gamma Ab2 and IFN-gamma Ab3) and the anti-ovalbumin antibody were diluted 1:16,000 in PBS. 10 μL of each antibody dilution was placed on two dots at each time point. The first time point was 17.5 hours before the addition of the goat anti-mouse HRP antibody (Santa Cruz Biotechnology, Santa Cruz Calif.). Antibodies were applied to other dots at 8, 7, 6, 5, 4, 3, 2, 1, 0.5, and 0.25 hrs before the addition of the goat anti-mouse HRP antibody. At the end of the time course, the excess solution on the dots was aspirated off and the sheet was washed three times (5 minutes each) with PBST. A layout of the times in which the antibody was added is provided in Table 9.

TABLE 9
Summary of the time course for the addition of the four tested antibodies

| Ab | | IFN | | |
|---|---|---|---|---|
| Applied | Ova Ab | Ab1 | IFN Ab2 | IFN Ab3 |
| (picomolar) | (165) | (19.14) | (235.125) | (358.05) |
| Addition of | 17.5 | 17.5 | 17.5 | 17.5 |
| Ab (Hrs) | 8 | 8 | 8 | 8 |
| | 7 | 7 | 7 | 7 |
| | 6 | 6 | 6 | 6 |
| | 5 | 5 | 5 | 5 |
| | 4 | 4 | 4 | 4 |
| | 3 | 3 | 3 | 3 |
| | 2 | 2 | 2 | 2 |
| | 1 | 1 | 1 | 1 |
| | 0.5 | 0.5 | 0.5 | 0.5 |
| | 0.25 | 0.25 | 0.25 | 0.25 |
| | No Ab | No Ab | No Ab | No Ab |

Incubation of Goat Anti-Mouse HRP Antibody and TMB Substrate

The entire sheet was incubated with 30 ml of goat anti-mouse HRP antibody that was diluted 1:1500 (266 ng/ml) in PBS. The reaction was allowed to incubate for 1 hour while shaking and then washed three times (10 minutes each) in PBST (0.1% Tween 20). The sheet was rinsed several times with deionized water. The sheet then was incubated with TMB H substrate (Moss Inc, Pasadena Md.).

Scanning and Analyzing the Array

The dried slide was scanned with a High Resolution scanner (Epson America, Long Beach, Calif.) at 2400 dpi in 16-bit greyscale file. The image was inverted using Photoshop Elements (Adobe Systems Inc., San Jose, Calif.) and saved as a TIFF file labeled with an additional “INVERTED.” The image was analyzed with the GenePix Pro 6.1 software (Molecular Devices, Sunnyvale, Calif.) and interpreted with Microsoft Excel spreadsheet software (Microsoft Corporation, Redmond, Wash.) and Graphpad Prism software (Graphpad Software, Inc., San Diego, Calif.).

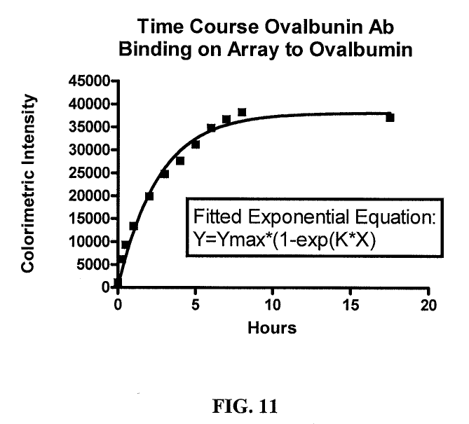

FIG. 11 is a graph reporting the anti-ovalbumin antibody binding to ovalbumin over a time course of about 18 hours, as measured in a frameless, multiplexed, miniaturized antigen array. The data in FIG. 11 shows the binding fitted to an exponential equation. The association rate gives a t_{1/2} of 1.8 hours showing that half of the antibody is bound in <2 hours. Table 10 provides additional analytical data on the time course of antibody/protein binding as measured in the multiplexed, miniaturized antigen array.

TABLE 10
Summary of the analytical data for the interaction between
anti-ovalbumin antibody and ovalbumin monitored over a time course.

| One phase exponential | |
|---|---|
| association | |
| Best-fit values | |
| YMAX | 38152 |
| K | 0.3804 |
| Half Time of Association | 1.822 hrs |
| Std. Error | |
| YMAX | 1263 |
| K | 0.03734 |
| 95% Confidence Intervals | |
| YMAX | 35337 to 40967 |
| K | 0.2972 to 0.4636 |
| Half Life | 1.495 to 2.332 |
| Goodness of Fit | |
| Degrees of Freedom | 10 |
| R² | 0.9833 |
| Absolute Sum of Squares | 3.18E+07 |
| Sy.x | 1783 |
| Constraints | |
| K | K > 0.0 |
| Data | |
| Number of X values | 12 |
| Number of Y replicates | 1 |
| Total number of values | 12 |
| Number of missing values | 0 |

Based on the data in FIG. 11, the percent of antibody bound at a given period can be predicted. Table 11 summarizes the predicted percent of bound antibody in a given time period.

TABLE 11
Summary of the predicted percent of antibody bound over a given
time period

| Hours of | Fraction |
|---|---|
| Binding | Bound |
| 1.8 | 0.50 |
| 3.6 | 0.75 |
| 5.4 | 0.88 |
| 7.2 | 0.94 |
| 9 | 0.97 |
| 10.8 | 0.98 |
| 12.6 | 0.99 |

### Example 4

### Determination of IC₅₀ and Ki Values Using Frameless, Multiplexed Microarrays

Printing of Interferon-Gamma and Ovalbumin

Three proteins, IFN-gamma, ovalbumin, and mouse IgG, were each printed four times on each nitrocellulose dot at 200 μg/ml in PBS. The polyester sheet contained a total of 96 nitrocellulose dots. The polyester sheet was dried in a desiccator for 15 minutes and then blocked for 1 hour in a non-protein block solution (Pierce Biotechnology, Rockford Ill.). The polyester sheet was washed three times for five minutes each with PBST, 0.1% Tween-20 and dried in a particle-free hood.

Incubation of Antibodies with Antigen in Solution Prior to Application to Nitrocellulose Dots

A dilution series of the IFN gamma and the ovalbumin were made so that the highest concentration of the soluble antigen would be 100 times greater than the concentration of the antibody. The antigen then was diluted 6 times, each dilution being 1 to 4 (thereby reducing the concentration by a factor of 5), in PBST (0.1% Tween-20). There were a total of eight (8) samples for each antibody tested: the initial sample where the concentration of soluble antigen is 100× greater than the concentration of antibody, the six serial dilutions, and one sample with no antigen. Each sample had a volume of 80 μL. The antibodies (IFN-gamma (Ab-1), IFN-gamma (Ab-2), IFN-gamma (Ab-3), and ovalbumin-Ab) were diluted to 2× concentration and 80 μL of each was added to the 8 wells that were designated for that antibody. Table 12 represents the layout of the plate in both final antigen and antibody concentrations.

TABLE 12
Summary of the final antigen and antibody concentrations for the three
antibodies tested

| | IFN gamma | IFN gamma | IFN gamma | Ovalbumin |
|---|---|---|---|---|
| | Ab1 | Ab2 | Ab3 | Ab |
| Concen- | 800/8 | 3560/35.6 | 1810/18.1 | 5430/54.3 |
| tration | 160/8 | 712/35.6 | 362/18.1 | 1086/54.3 |
| of Antigen | 32/8 | 142.4/35.6 | 72.4/18.1 | 217.2/54.3 |
| (ng/mL)/ | 6.4/8 | 28.5/35.6 | 14.5/18.1 | 43.4/54.3 |
| Concen- | 1.28/8 | 5.70/35.6 | 2.90/18.1 | 8.69/54.3 |
| tration | 0.256/8 | 1.14/35.6 | 0.579/18.1 | 1.74/54.3 |
| of Antibody | 0.0512/8 | 0.228/35.6 | 0.116/18.1 | 0.348/54.3 |
| (ng/mL) | 0/8 | 0/35.6 | 0/18.1 | 0/54.3 |

The plate was placed on a shaker at room temperature and was shaken for 2 hours. 10 μl of each of the 32 different antigen/antibody solutions was placed on three nitrocellulose dots (containing IFN-gamma, ovalbumin and IgG) and incubated in a humidity chamber for 3 hours. The excess was aspirated off and the sheet was washed three times (5 minutes each) with PBST (0.1% Tween-20) and rinsed with deionized water.

Addition of Goat Anti-Mouse HRP Antibody and TMB Substrate

The entire sheet was incubated with 30 ml of goat anti-mouse HRP antibody that was diluted 1:1500 (266 ng/ml) in PBST. The reaction was allowed to incubate for 1 hour while shaking and then washed three times (10 minutes each) in PBST (0.1% Tween-20). The sheet was rinsed several times with deionized water. The sheet then was incubated with TMB H substrate (Moss Inc, Pasadena, Md.).

Scanning and Analyzing the Array

The dried slide was scanned with a High Resolution scanner (Epson America, Long Beach, Calif.) at 2400 dpi in 16-bit grayscale file. The image was inverted using Photoshop Elements (Adobe Systems Inc., San Jose, Calif.) and saved as a TIFF file labeled with an additional “INVERTED.” The image was analyzed with the GenePix Pro 6.1 software (Molecular Devices, Sunnyvale, Calif.) and interpreted with Microsoft Excel spreadsheet software (Microsoft Corporation, Redmond, Wash.) and Graphpad Prism software (Graphpad Software, Inc., San Diego, Calif.).

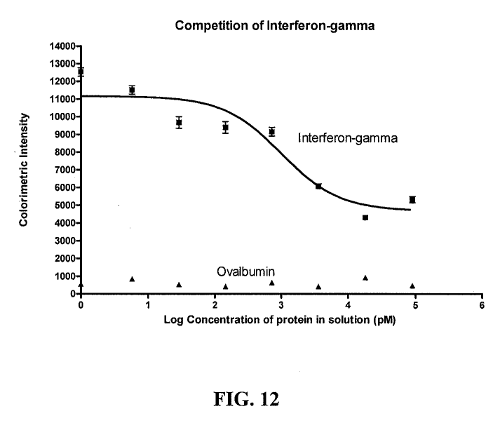

The results are reported in FIG. 12 and Table 13. The Kᵢ values were calculated based on the curve fit, the Kd value, and the concentration of antibody. The Kᵢ, unlike the IC₅₀, is not defined under specific conditions and is a good comparator for different antibodies. As the concentration of interferon-gamma in solution increases, the calorimetric intensity decreases, demonstrating that there is less available antibody for binding to the antigen on the array (interferon-gamma). Thus, the methods of the present invention can be used to identify molecules that interfere with protein interaction, or enhance protein interactions. For instance, the methods of the present invention can be used to identify antibodies that interfere with protein-protein interactions or to identify antibodies with higher affinities for certain proteins. In addition, the present methods can be used to identify a small molecule and/or a peptide mimetic that interferes, disrupts, or enhances molecular interactions.

TABLE 13
Summary of the analytical data demonstrating the Ki of a soluble
protein that competes for
binding to an antibody

| One site competition | |
|---|---|
| Best-fit values | |
| BOTTOM | 4683 |
| TOP | 11175 |
| LOGEC50 | 2.999 |
| EC50 | 997.5 |
| KI | 147.8 pM |
| Ligand (Constant) | 121 pM |
| Kd (Constant) | 21.05 pM |
| Std. Error | |
| BOTTOM | 260.7 |
| TOP | 195.5 |
| LOGEC50 | 0.09925 |
| 95% Confidence Intervals | |
| BOTTOM | 4165 to 5202 |
| TOP | 10786 to 11564 |
| LOGEC50 | 2.802 to 3.196 |
| EC50 | 633.2 to 1572 |
| KI | 93.85 to 232.9 |
| Goodness of Fit | |
| Degrees of Freedom | 93 |
| R² | 0.8348 |
| Absolute Sum of | 1.32E+08 |
| Squares | |
| Sy.x | 1192 |
| Data | |
| Number of X values | 8 |
| Number of Y replicates | 12 |
| Total number of values | 96 |
| Number of missing | 0 |
| values | |

### Example 5

### Selection of Matched Pair Antibodies Using Frameless, Multiplexed Microarrays

“Spot on Dots”—Capture of IFN Gamma

Four different capture anti-IFN-gamma antibodies (three from Primorigen and one from eBioscience) were manually spotted onto six (6) nitrocellulose areas (dots) each in 1 μl volumes at a concentration of 200 μg/ml diluted in PBS. The dots were dried so that the antibodies would become immobilized and the 3 by 8 dot sheet was blocked for one hour while shaking in a PBS Non-Protein Block (Pierce, Rockford Ill.). The blocking solution was washed off with PBST (0.1% tween-20) three times (1 minute each). Eleven of the dots were treated with 10 μl of the 10 ng/ml (1 mg/ml BSA carrier) eBioscience IFN gamma, another eleven dots were treated with 10 μl of the 10 ng/ml CIBA-GEIGY IFN gamma, and two dots were left untreated as negative controls. The sheet then was incubated in a humidity chamber for 30 minutes. The excess solution was aspirated off and the sheet was washed three times (1 minutes each) with PBST (0.1% tween-20). The slide was allowed to dry. Table 14 provides a representation of the layout of the capture antibodies and the antigens that were used.

TABLE 14
Summary of the layout of the capture antibodies and antigens used

| | | | |
|---|---|---|---|
| Capture | Primorigen Ab1/ | Primorigen Ab1/ | Primorigen Ab1/ |
| Antibody/ | CIBA-GEIGY IFN | CIBA-GEIGY IFN | CIBA-GEIGY |
| Antigen | | | IFN |
| | Primorigen Ab2/ | Primorigen Ab2/ | Primorigen Ab2/ |
| | CIBA-GEIGY IFN | CIBA-GEIGY IFN | CIBA-GEIGY |
| | | | IFN |
| | Primorigen Ab3/ | Primorigen Ab3/ | Primorigen Ab3/ |
| | CIBA-GEIGY IFN | CIBA-GEIGY IFN | CIBA-GEIGY |
| | | | IFN |
| | eBioscience Ab/ | eBioscience Ab/ | eBioscience Ab/ |
| | CIBA-GEIGY IFN | CIBA-GEIGY IFN | No Antigen |
| | Primorigen Ab1/ | Primorigen Ab1/ | Primorigen Ab1/ |
| | eBioscience IFN | eBioscience IFN | eBioscience IFN |
| | Primorigen Ab2/ | Primorigen Ab2/ | Primorigen Ab2/ |
| | eBioscience IFN | eBioscience IFN | eBioscience IFN |
| | Primorigen Ab3/ | Primorigen Ab3/ | Primorigen Ab3/ |
| | eBioscience IFN | eBioscience IFN | eBioscience IFN |
| | eBioscience Ab/ | eBioscience Ab/ | eBioscience Ab/ |
| | eBioscience IFN | eBioscience IFN | No Antigen |

Detection of IFN Gamma

Each dot was incubated for one hour with 10 μl of a 1 μg/ml solution of anti-human IFN gamma biotinylated antibody (eBioscience, San Diego, Calif.) diluted in PBST. The excess solution was aspirated off and the sheet was washed three times (1 minute each) with PBST. Each dot was then incubated for 30 minutes in a humidity chamber with 10 μl of a 1:250 dilution of avidin HRP (eBioscience) diluted in PBS r. Again, the excess was aspirated off and washed 3 times (5 minutes each) with PBST and rinsed with deionized water several times.

Incubation with Substrate and Imaging

The entire sheet was covered with 1-2 ml of TMB H substrate (Moss Inc, Pasadena, Md.) for 5 minutes and rinsed several times with deionized water to stop the development. The sheet was allowed to dry in a particle free hood and then scanned using a high resolution scanner (Epson) at 2400 dpi in a 16-bit grayscale file.

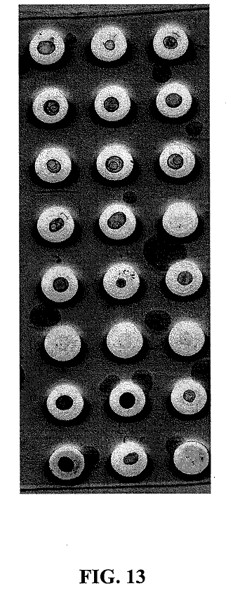

The data demonstrate that the anti-interferon-gamma Ab2 recognized only one formulation of the interferon gamma when used in a sandwich ELISA with the eBioscience detect antibody. FIG. 13, row 6 shows the lack of signal when using anti-interferon gamma Ab2.

The other two antibodies, Ab1 and Ab3, when used as capture antibodies worked with the detection antibody from eBioscience. Thus, the data demonstrate that the present invention provide a rapid, efficient and accurate method to characterize protein-protein interactions including but not limited to the interactions between an antibody and an antigen.

### Example 6

### Simultaneously Using a Frameless Microarray to Microarray an Antigen Immunoassay and a Sandwich Immunoassay to Characterize an Antibody

The methods of the present invention can be used to characterize a biotinylated antibody, (Ab-10-biotin) and to determine if a matched pair antibody can be identified. A microarray was prepared in which the antibody binding was measured in both an antigen immunoassay and in a sandwich immunoassay. Three target proteins (Nanog, Tubb4, and NeuroD1) and 7 different anti-Nanog capture antibodies (Ab1, Ab2, Ab3, Ab4, Ab5, Ab6, Ab7) were each printed in duplicate at 200 μg/ml, on nitrocellulose areas (dots). A positive control also was printed, biotinylated antibody (Ab 9). The entire array was blocked with Pierce Non-Protein (Fisher Scientific, Pittsburgh, Pa.) block for 1 hour, rinsed 3 times for 30-seconds with PBST, 0.05% Tween-20; rinsed two times for 30-seconds with ultra-pure water, and then allowed to dry in a clean hood. Purified Nanog protein (expressed in a baculovirus expression system at Primorigen Biosciences, LLC) was made at 20 ng/mL in 1 mg/mL BSA in PBS. Five μL of the Nanog containing samples were incubated for 1 h at room temp in a high-humidity chamber on each of the arrayed nitrocellulose dots. The excess was aspirated off quickly and the entire sheet was submerged three times for 30-seconds in PBST.

After a 1:1000 dilution in 1 mg/mL BSA in PBS, 5 μL of biotinylated Nanog detection antibody, Ab 10-biotin, was placed on each dot, incubated and washed in the same manner as used with the Nanog protein. Then, 5 μL of alkaline phosphatase conjugated streptavidin (Moss Inc., Pasadena, Md.), diluted to 1 μg/mL in 1 mg/mL BSA, was placed over the entire array and incubated for 30 min. in a high-humidity chamber at room temperature. The array was washed five times, each for one-minute, in PBST, 0.05% Tween-20 and rinsed once with ultra-pure water. The array then was incubated with Moss BCIP/NBT Plus until the signal could be detected (˜15 min). Determining the sensitivity of the sandwich assay on the membranes was a goal of this experiment.

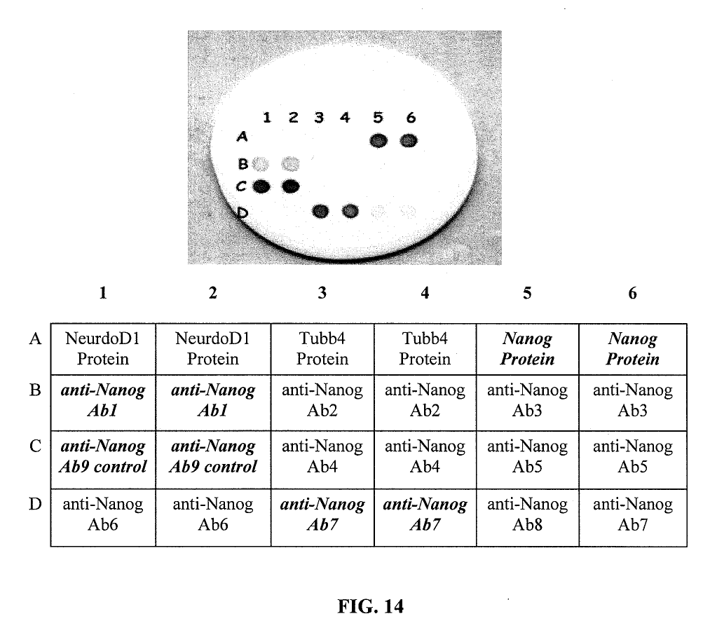

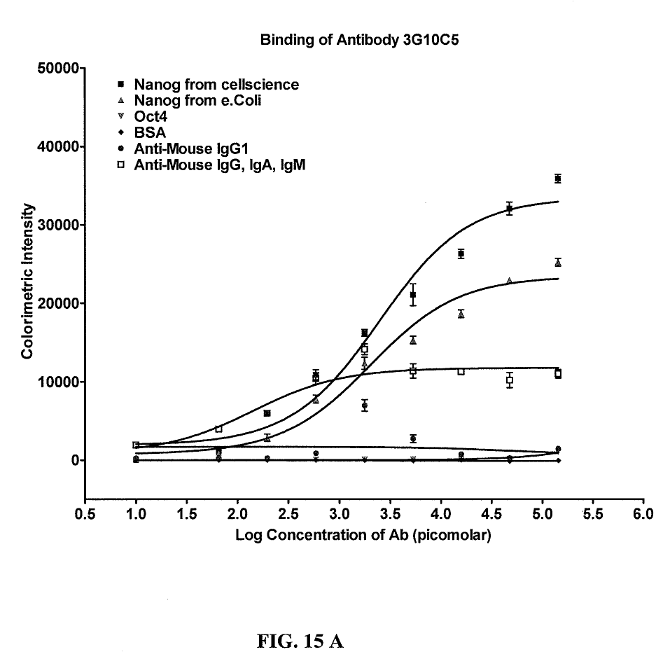

The dried microarray was scanned with a High Resolution scanner (Epson America, Long Beach, Calif.) at 2400 dpi in 16-bit grayscale file (FIG. 14). The image was inverted using Photoshop Elements (Adobe Systems Inc., San Jose, Calif.) and saved as a TIFF file labeled with an additional “INVERTED.” The image was analyzed with the GenePix Pro 6.1 software (Molecular Devices, Sunnyvale, Calif.) and interpreted with Microsoft Excel spreadsheet software (Microsoft Corporation, Redmond, Wash.).

Using the array, Ab-10-biotin detected the Nanog protein bound directly to the surface (row A, columns 5-6, FIG. 14). Ab-10-biotin also detected Nanog protein tethered to the surface by a capture antibody (row B, columns 1-2, row D, columns 3-4 on FIG. 14). Ab-10-biotin did not interact with Nanog tethered to anti-Nanog Ab 2, 3, 4, 5 or 6. Ab-10-biotin did not interact with any of the other proteins (NeuroD1, Tubb4) arrayed on the surface.

The data presented in FIG. 14 show that a biotinylated antibody can be tested simultaneously in an antigen immunoassay and in a sandwich ELISA. This experiment demonstrates that a biotinylated antibody (AB 10-anti-nanog bio) can be tested for binding to its protein target. Furthermore, even if the sandwich ELISA provides a negative result, it may be because the two antibodies are not matched pairs as opposed to the proposition that biotinylation destroyed the antibody binding capacity. These data also demonstrate that the specificity of binding of the antibody can be determined using non-specific proteins. Both the biotinylated detection antibody and the target protein containing solution can be diluted to determine the detection level for the assay.

The experiment can also be performed with different concentrations of the biotinylated antibody to determine the relative dissociation constant between the target protein(s) and the antibody. It can also be used to determine the concentration of the biotinylated detection antibody that provides the best sensitivity and specificity in the sandwich immunoassay.

### Example 7

### Simultaneously Determining the Concentration of an Antibody in a Solution and Measuring Several Additional Binding Parameters

An experiment was performed to analyze binding of an antibody in solution. The experiment was also designed to demonstrate that the following activities can be performed on the same array: (a) determine the antibody concentration by comparing it to an immunoglobulin standard curve on the array; (b) determine an apparent dissociation constants between the antibody and a target protein(s); (c) determine an apparent dissociation constant between the antibody and other, non-target, proteins to measure specificity; and (d) determine the isotype of the sample antibody by using various isotype-specific capture antibodies on the array surface. The above-mentioned activities and characterizations are meant as a representative list, and not as an exhaustive list. There are a plethora of characterizations that can be obtained from the arrays. Eight different proteins (6 protein targets and 2 capture antibodies) were printed at 200 ug/mL in triplicate on each nitrocellulose area (“dot”) of a 96 nitrocellulose dot sheet. Table 15 provides a list of the proteins used in this example.

TABLE 15
Layout of the 8 proteins on each of the 96 dots, a 2 × 4 grid

| | |
|---|---|
| 1 Cell Sciences Nanog Protein | 2 BSA |
| 3 Primorigen Nanog Protein (E. coli) | 4 Mouse IgG (control only) |
| 5 Primorigen Nanog Protein (baculovirus) | 6 Anti-Mouse IgG1 |
| 7 Primorigen Oct 4 (E. coli) | 8 Anti-Mouse IgG, IgA, IgM |

The sheet was blocked with NAP buffer (G-biosciences, Maryland Heights, Mo.) for one hour at room temperature, washed 3 times with PBST, rinsed with 20 mM phosphate, and allowed to dry in a clean hood.

The sources of reagents that were not produced by Primorigen Biosciences, LLC are listed in Table 16.

TABLE 16
Sources of Reagents

| | | | | Lot |
|---|---|---|---|---|
| Material | Concentration | Source | Part Number | Number |
| Nanog Protein | — | Cell Science (Canton, | CRN000B | 3119401 |
| | | MA) | | |
| BSA | 10 mg/mL | Sigma (St. Louis, MO) | A7906 | 29H1282 |
| Mouse IgG | 5.6 mg/mL | Jackson (West Grove, | 015-000- | 78900 |
| | | PA) | 003 | |
| Anti-Mouse IgG1 | 1.0 mg/mL | Rockland | 610-4140 | 15781 |
| Anti-Mouse IgG, IgA, | 1.0 mg/mL | Rockland (Gilbertsberg, | 610-101- | 16896 |
| IgM | | PA) | 430 | |
| Anti Nanog from | 0.5 mg/mL | eBioscience (San Diego, | 14-5768-80 | E029300 |
| eBiosciences | | CA) | | |

The cell culture supernates, each containing a different monoclonal antibody, were diluted 1/10 in PBST and then serially diluted 1/3 seven times for 8 total dilutions and a blank. Five microliters of each diluted solution were placed on an arrayed dot and incubated for one hour at room temperature in a humid chamber. Each row on the anay contained dilutions of one antibody sample.

The order of diluted antibody samples on the microarray, from the top row (1) to bottom row (8) is: row 1 3G10C5 anti-nanog; row 2 4E7H5 anti-nanog; row 3 3F6B5 anti-nanog; row 4 2E11F5 anti-nanog; row 5 3G6E6 anti-nanog; row 6 4H3B10 anti-brachury (negative control); row 7 anti-nanog Ab from eBiosciences (San Diego, Calif.) spiked into cell culture media; and row 8 mouse IgG in media to generate the antibody standard curve (27 ug/mL initial concentration).

Summarily, the entire array of dots contains the same 8 printed proteins. For the first row, eight different dilutions of the 3G10C5 antibody are placed (5 μL) on the first 8 dots and PBS T buffer is placed on dot 9. The antibody in the sample should bind to the target Nanog protein spots and at the same time the anti-mouse antibodies should capture the antibody out of the solution. Each subsequent row is treated the same way but with a different diluted antibody.

Once binding had occurred, the sheet was washed as described after the blocking step and each dot was incubated with 5 μL of a 1:1000 dilution of anti-mouse AP in PBST for one hour at room temperature in a humid chamber. The sheet was washed 5 times with PBST and incubated with BCIP/NBT alkaline phosphatase substrate until blue color appeared, ˜9 minutes. The reaction was stopped by rinsing with the sheet with deionized water several times and the sheet was dried in a laminar flow hood.

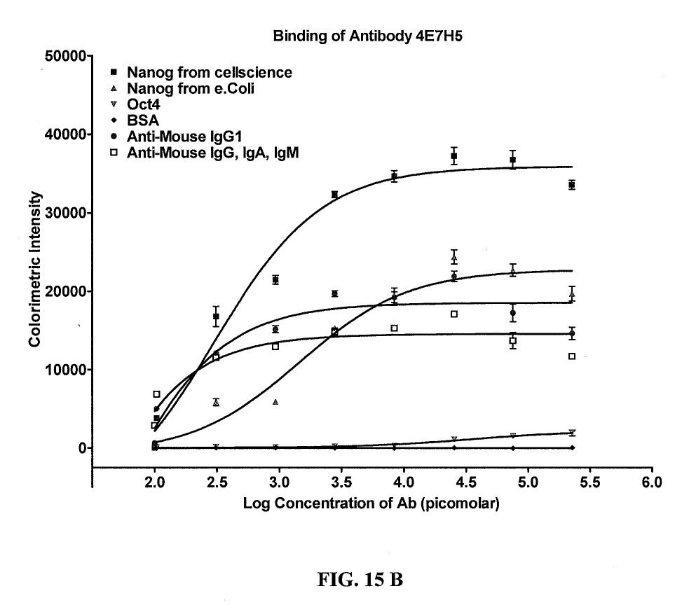

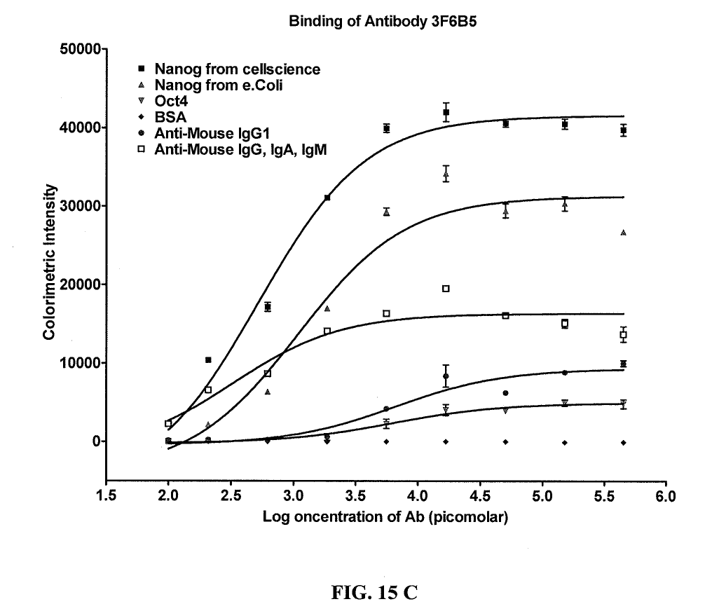

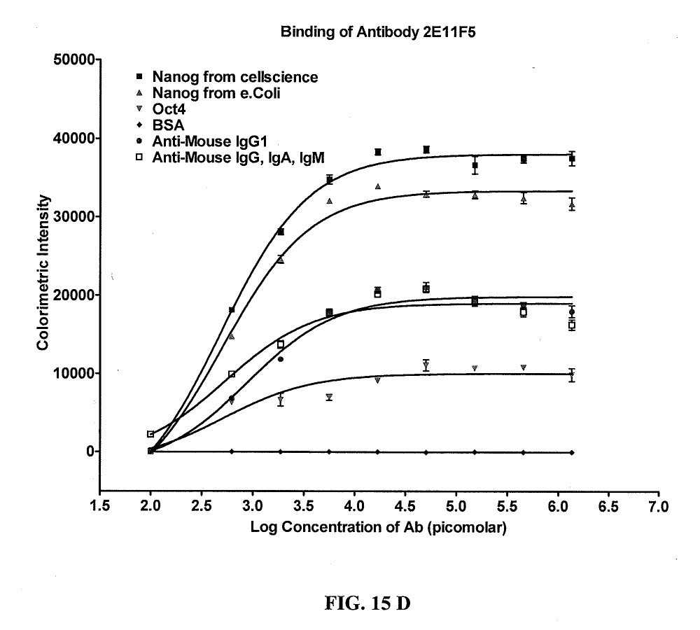

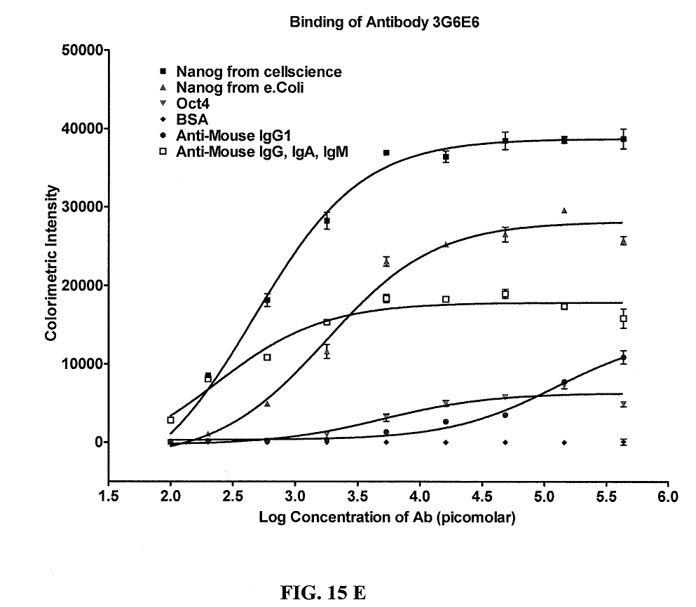

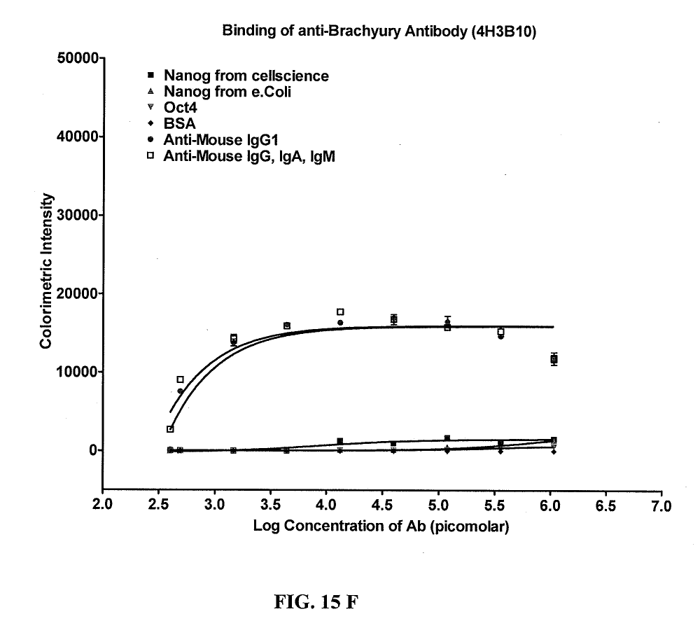

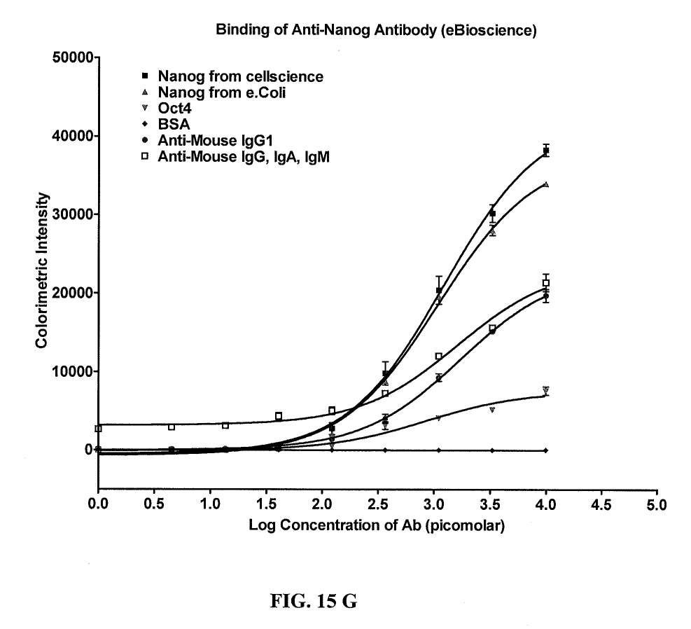

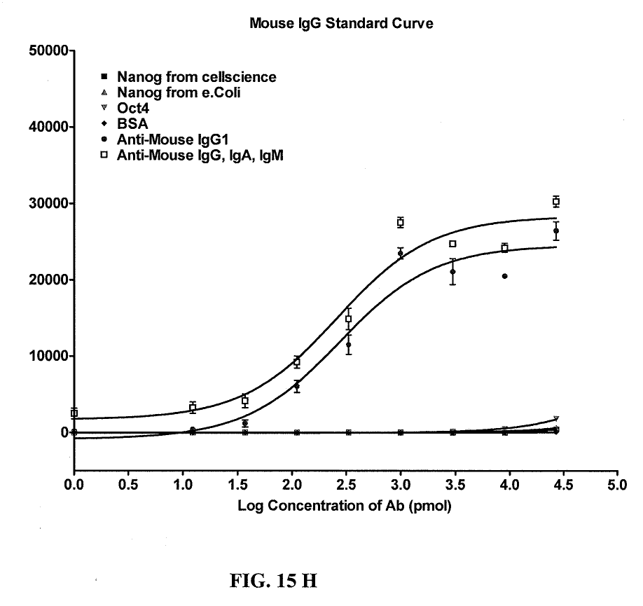

The dried microarray was scanned with a high resolution scanner (Epson America, Long Beach, Calif.) at 2400 dpi in 16-bit grayscale file. The image was inverted using Photoshop Elements (Adobe Systems Inc., San Jose, Calif.) and saved as a TIFF file labeled with an additional “INVERTED.” The image was analyzed with the GenePix Pro 6.1 software (Molecular Devices, Sunnyvale, Calif.) and interpreted with Microsoft Excel spreadsheet software (Microsoft Corporation, Redmond, Wash. Equilibrium binding constants and curve fits (FIGS. 15A-15H) were determined using Graphpad Prizm software (Graphpad, San Diego, Calif.).

FIGS. 15A-15H are graphs reporting the differential binding of various anti-Nanog antibodies to various proteins and capture by two anti-IgG antibodies. FIG. 15A is a graph reporting the binding of antibody 3G10C5; the antibody was not captured by the IgG1 capture antibody indicating that it is not an IgG 1, which is a preferred antibody isotype. 3G10C5 did bind to the capture antibody detecting IgG, IgA, and IgM.

FIG. 15B is a graph reporting the binding of the antibody 4E7H5. Antibody 4E7H5 was an IgG1 antibody isotype, and the antibody bound to both sources of Nanog but with slightly different affinities. Antibody 4E7H5 showed very little binding to Oct 4 and BSA.

FIG. 15D is a graph reporting the binding of antibody 2E11F5. Antibody 2E11F5 recognized both sources of Nanog but showed poor specificity; significant binding to Oct 4 was detected, a protein to which it should not bind.

FIG. 15E is a graph reporting the binding of antibody 3G6E6. Antibody 3G6E6 bound both sources of Nanog protein and BSA but with affinity differences of >500 fold. The antibody can be effectively used over a certain concentration range.

FIG. 15F is a graph reporting the binding of antibody 4H3B10, which was a negative control and should not bind to any of the proteins. Antibody 4H3B10 did not show significant binding to any of the tested proteins, but was captured by both anti-Ig antibodies, showing it is an IgG1.

FIG. 15H is a graph reporting a standard curve of mouse IgG. The calorimetric intensity of this curve is used to calculate the antibody concentration in the other samples.

Some of the analytical data, using Graphpad Prizm software, is shown in Table 17. The dissociation constants (Kd) valued are listed for one protein target, the Nanog protein purchased from E Biosciences.

TABLE 17
Calculated Kd for various anti-Nanog antibodies

| | Starting | | |
|---|---|---|---|
| | Concentration | Starting | Calculated |
| | in Titration | Concentration in | Kd (pM) to |
| Monoclonal ID | (pg/mL) | Titration (pM) | Nanog Protein |
| 3G10C5 anti-nanog | 21.5 | 143.4 | 2486.0 |
| 4E7H5 anti-nanog | 34.0 | 226.9 | 295.9 |
| 3F6B5 anti-nanog | 68.0 | 453.6 | 523.8 |
| 2E11F5 anti-nanog | 204.8 | 1365.7 | 482.5 |
| 3G6E6 anti-nanog | 65.4 | 436.0 | 465.6 |
| Anti-nanog from | 27.0 | 180.0 | 1229.0 |
| eBiosciences | | | |

Although the invention has been described in considerable detail by the preceding specification, this detail is for the purpose of illustration and is not to be construed as a limitation upon the following appended claims. All cited reports, references, U.S. patents, allowed U.S. patent applications, and U.S. patent application Publications are incorporated herein by reference.

What is claimed:

1. A method for assaying a molecular interaction comprising: (a) applying a sample to a microarray; and (b) measuring a molecular interaction between at least two molecules.

2. The method of claim 1, wherein said molecular interaction is expressed as an equilibrium binding constant.

3. The method of claim 1, wherein the microarray is a frameless microarray.

4. The method of claim 3, wherein said frameless microarray comprises 96 segregated membranes.

5. The method of claim 4, wherein said sample is applied in a volume selected from the group consisting of: 4, 6 and 10 μl.

6. The method of claim 3, wherein said frameless microarray comprises 384 segregated membranes.

7. The method of claim 6, wherein said sample is applied in a volume selected from the group consisting of: 0.5, 1 and 3 μl.

8. The method of claim 3, wherein said frameless microarray comprises 1,536 segregated membranes.

9. The method of claim 8, wherein said sample is applied in a volume selected from the group consisting of: 0.25, 0.5 and 1 μl.

10. The method of claim 3, wherein said frameless microarray comprises: (a) at least two segregated membranes coupled to a substrate, wherein said membranes comprise a composition comprising nitrocellulose, and further wherein said composition is formulated to maintain an applied fluid within the perimeter of the membrane and (b) an analyte coupled to said membranes.

11. The method of claim 1, wherein at least one molecule is an antibody.

12. The method of claim 11, wherein said antibody contains a label selected from the group consisting of: a fluorescent molecule, alkaline phosphatase, horseradish peroxidase and metal.

13. The method of claim 11, wherein said antibody is selected from the group consisting of monoclonal, polyclonal, a fragment of an antibody, an active region of an antibody, and a conserved region of an antibody.

14. The method of claim 1, wherein one molecule is an antibody in solution and a second molecule is bound to the microarray surface.

15. The method of claim 1, wherein one molecule is an antibody in solution and at least two potential binding target molecules are bound to the microarray surface.

16. The method of claim 1, wherein said sample is a cell extract.

17. A method for assaying a molecular interaction comprising: (a) applying a sample to a microarray, wherein at least one molecule is coupled to the surface of said microarray; (b) quantifying the amount of an antibody in said sample; and (c) measuring the equilibrium binding between said antibody and said molecule.

18. The method of claim 17, wherein said microarray is a frameless microarray.

19. The method of claim 17, wherein said antibody is selected from the group consisting of:
monoclonal, polyclonal, a fragment of an antibody, an active region of an antibody, and a conserved region of an antibody.

20. The method of claim 17, wherein said sample is selected from the group consisting of a cell, a cell extract, a plant extract, lectin, tissue, an organ, blood, serum, plasma, saliva, urine, tear, vaginal secretion, sweat, umbilical cord blood, chorionic villi, amniotic fluid, an embryo, lymph fluid, cerebrospinal fluid, semen, mucosa secretion, peritoneal fluid, sputum, respiratory exudates, ascetic fluid, fecal matter, and body exudates.

21. The method of claim 17, wherein said molecule is selected from the group consisting: a probe, an antigen, an antibody, a monoclonal antibody, a polyclonal antibody, a fragment of an antibody, an active region of an antibody, a conserved region of an antibody, a small molecule inhibitor, a protein, a fragment of a protein, an active region of a protein, a peptide, a peptide mimetic, and an amino acid sequence.

22. A method for assaying a molecular interaction comprising: (a) applying a sample to a microarray; (b) measuring binding between an antibody and a molecule coupled directly to the microarray surface; and (c) measuring binding between the antibody and the same molecule coupled to the surface by another antibody, which binds to a different part of the target molecule.

23. The method of claim 22, wherein said microarray is a frameless microarray.

24. The method of claim 22, wherein said antibody is selected from the group consisting of: monoclonal, polyclonal, a fragment of an antibody, an active region of an antibody, and a conserved region of an antibody.

25. The method of claim 22, wherein said antibody is in a sample selected from the group consisting of a cell, a cell extract, a plant extract, lectin, tissue, an organ, blood, serum, plasma, saliva, urine, tear, vaginal secretion, sweat, umbilical cord blood, chorionic villi, amniotic fluid, an embryo, lymph fluid, cerebrospinal fluid, semen, mucosa secretion, peritoneal fluid, sputum, respiratory exudates, ascetic fluid, fecal matter, and body exudates.

26. The method of claim 22, wherein said molecule is selected from the group consisting of a probe, an antigen, an antibody, a monoclonal antibody, a polyclonal antibody, a fragment of an antibody, an active region of an antibody, a conserved region of an antibody, a small molecule inhibitor, a protein, a fragment of a protein, an active region of a protein, a peptide, a peptide mimetic, and an amino acid sequence.

27. A method of assaying a molecular interaction comprising: (a) applying a sample to a frameless microarray; and (b) measuring a time course of equilibrium between at least two molecules.

28. The method of claim 27, wherein at least one molecule is an antibody in solution and the time course of binding is measured to more than one protein target simultaneously.

29. The method of claim 28, wherein specificity of binding of the antibody is characterized using at least one non-specific protein.

30. A method for assaying a molecular interaction comprising: (a) applying a sample containing an analyte to a frameless microarray, wherein said microarray has at least one target molecule and at least one non-target molecule coupled to the surface; (b) determining binding specificity of the analyte to the target molecule and the non-target molecule; and (c) determining a dissociation constant for the analyte and the target molecule and a dissociation constant for the analyte and non-target molecule.

31. The method of claim 30, wherein said analyte is an antibody.

32. The method of claim 31, further comprising determining the isotype of the antibody.

33. The method of claim 31, further comprising determining the concentration of the antibody.

34. The method of claim 30, wherein said target molecule is coupled directly to the surface of the microarray and the same target molecule is coupled to the surface by another antibody, which binds to a different part of the target molecule.
